(19) United States
(12) Patent Application Publication
(10) Pub. No.: US 2008/0041996 A1
(43) Pub. Date: Feb. 21, 2008

(54) Methods and apparatus for processing recyclable containers

(75) Inventors: John Shaw, Falmouth, ME (US); Norm Trudel, Westbrook, ME (US); Mark Massey, Wellesley, MA (US)

Correspondence Address: WOLF GREENFIELD & SACKS, P.C., 600 ATLANTIC AVENUE, BOSTON, MA, 02210-2206, US

(73) Assignee: Count & Crush, LLC, Scarborough, ME (US)

(21) Appl. No.: 11/481,569

(22) Filed: Jul. 6, 2006

(51) Int. Cl. B02C 1/08

(52) U.S. Cl. 241/236

(57) ABSTRACT

Methods and apparatus are provided for processing and densifying recyclable materials. In one embodiment, a recyclable container densification device is provided for reliably rendering a bar code of a recyclable container unreadable. In another embodiment, the densification device is reconfigurable to be able to produce different types of recovered material from recyclable containers. In another embodiment, a chute is provided that promotes the entry of recyclable materials into a densification device by dropping the materials directly thereon. An additional embodiment includes a recycling system manufactured from densification modules that can be assembled to in different numbers and mixes to meet the needs of different customers.

### FIELD OF INVENTION

This invention relates to methods and apparatus used for densifying recyclable containers.

### BACKGROUND OF INVENTION

Many states impose a cash deposit on beverage containers purchased by consumers to minimize litter and encourage recycling. For example, a number of states impose deposits of up to fifteen cents for each can, bottle and/or other container sold. Typically, after a consumer consumes the beverage stored in the container, the consumer presents the container at a return center (e.g., at a supermarket or standalone redemption center) for return of the deposit. The return center may subject the container to a recycling process through which the container is destroyed and converted into recovered material, so that the material from which the container is formed may be recovered for reuse. Containers may be formed of any of numerous materials, such as glass, plastic, aluminum, steel, and other materials.

The redemption center typically identifies a distributor for each type of container, and delivers the destroyed containers to the distributor for reimbursement. Typically, a redemption center receives a delivery of empty containers, sorts the containers (e.g., according to material), and identifies and counts the containers to provide this information to the distributor. The return center may crush or shred each container to reduce its volume, and package the containers in bulk for transportation to the distributor.

Distributors may have different requirements for the recovered material. Additionally, some states or localities may have regulations that specify the form or density for acceptable recovered material. ‘Flake-like’ recovered material, which is typically shredded and densified by about factor of 10, is required in some areas and is generally in the form of flat ½ inch by ½ squares. Other areas specify that recovered material be in a ‘strip-like’ form, which is typically densified by between a factor of between 2 and 4 through the densification process. Strip-like recovered material and is somewhat larger than flake-like recovered material and is generally in the form or rectangular strips.

Often, the process of sorting and counting containers is performed manually, such that containers may be counted incorrectly or credit may be assigned in error for certain containers. For example, a redemption center processing a large delivery may fail to notice that the delivery contains containers for which no deposit was paid (e.g., containers which were purchased by a consumer in a state in which no deposit is imposed). Thus, a redemption center may incorrectly pay a consumer for delivered containers. In addition, the manual process of accounting for each container introduces the possibility that a redemption center may overstate the number of containers to a distributor, such that the distributor may overpay the redemption center.

Most recyclable containers have a roughly 1½ inch by 1 inch barcode that can be read to identify the type and source of the container. Systems that rely on reading such barcodes to identify containers and credit customers with refunds may be subject to double counting. For instance, an unscrupulous consumer may pass the same recyclable container through a system more than once to improperly receive multiple refunds if appropriate safeguards are not in place.

Recently, some return centers have begun using “reverse vending machines” (RVMs) to receive containers from consumers. These machines may be configured to automatically receive specific types of recyclable containers, and count, identify and densify each container. Reverse vending machines may provide accounting information so that a consumer and return center may be reimbursed appropriately for containers delivered. However, many return centers are not equipped with reverse vending machines, as the cost of a recycling machine may be prohibitive for smaller outlets, and the RVM process is inconvenient for consumers.

The requirements of individual redemption centers can vary greatly. Some centers have extremely high throughput requirements and may also need to accommodate a wide variety of recyclable containers of different types of recovered material. Still, other redemption centers, such as those typically found at smaller grocery stores, may have lower throughput requirements, and may only wish to accept certain types of recyclable containers. The applicant has appreciated that, given the wide variety of customer requirements, a need exists for a common system that can be reconfigured into different forms to accommodate the needs of different redemption centers.

### SUMMARY OF INVENTION

In one embodiment, a recyclable container densification device is provided for rendering a bar code of a recyclable container unreadable. The device comprises a housing defining a densification area. A first shaft extends at least partially through the densification area. The device also comprises a first set of blade wheels, each blade wheel of the first set having a peripheral surface with two or more blades extending therefrom and a central aperture for mounting each blade wheel of the first set to the first shaft. The first set of blade wheels is mountable to the first shaft to form a first rotatable shredding assembly. The device also comprises a second shaft substantially parallel to the first shaft that extends at least partially through the densification area and a second set of blade wheels, each blade wheel of the second set having a peripheral surface with two or more blades extending therefrom and a central aperture for mounting each blade wheel of the second set to the second shaft. The second set of blade wheels is mountable to the second shaft to form a second rotatable shredding assembly. The first and second rotatable shredding assemblies are positioned to form a mesh between the first and second sets of blade wheels. The device also comprises a motor for rotating the first and second shredding assemblies relative to one another to draw recyclable containers into the mesh for densification and to render a bar code of the recyclable container unreadable.

In another embodiment, a reconfigurable recyclable material densification device is provided. The device comprises a housing defining a densification area. A first shaft extends at least partially through the densification area. The device also comprises a first set of blade wheels, each blade wheel of the first set having a peripheral surface with two or more blades extending therefrom and a central aperture for mounting each blade wheel of the first set to the first shaft. The first set of blade wheels is mountable to the first shaft to form a first reconfigurable rotatable shredding assembly. A second shaft substantially parallel to the first shaft extends at least partially through the densification area. The device also comprises a second set of blade wheels, each blade wheel of the second shaft having a peripheral surface with two or more blades extending therefrom and a central aperture for mounting each blade wheel of the second set to the second shaft. The second set of blade wheels is mountable to the second shaft to form a second reconfigurable rotatable shredding assembly. The first and second rotatable shredding assemblies are positioned to form a mesh between the first and second sets of blade wheels. Each of the first and second set of blade wheels are configured to be mounted to the first and second shafts in at least a first mesh configuration and a second mesh configuration.

In another embodiment, a system for densifying recyclable materials is disclosed. The system comprises a housing that defines a densification area. The housing has an opening at an upper surface to receive recyclable materials for densification. The system also comprises a mechanism positioned interior to the housing. The mechanism is configured to densify recyclable materials received in the densification area. The system also comprises a gate that is incorporated into a conveyor path that, when opened, allows materials to fall toward the densification area. A chute defines a pathway between the gate and the densification device along which materials travel without incurring substantial contact with the chute or other obstacles.

In still another embodiment, a method of manufacturing a system for densifying recyclable materials is disclosed. The method comprises providing a front end module and a back end module. The method includes selecting one or more densification modules from a group consisting of: a first densification module having a plurality of densification devices of a first type, a second densification module having a plurality of densification devices of a second type different from the first type, and a third densification device having one or more each of the first type of densification device and the second type of densification device. The first densification module, the second densification module, and the third densification module each have a commonly designed input face configured to mate with a commonly designed output face of another densification module. The method also comprises mating an input face of each densification module selected from the group to an output face of another densification module selected from the group or the front end module, and mating an input face of the back end module to an output face of a densification module selected from the group.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart showing a process for processing recyclable containers, according to one embodiment of the invention;

FIG. 2 is a top view diagram of an apparatus for processing recyclable containers, according to one embodiment of the invention;

FIG. 3 is a block diagram showing an assembly for determining characteristics of a recyclable container, according to one embodiment of the invention;

FIGS. 4A-4B depict an assembly for conveying a recyclable container to a densification device, according to one embodiment of the invention;

FIG. 5 depicts an assembly used for shredding certain recyclable containers, according to one embodiment of the invention;

FIGS. 6A-6B depict an assembly used for crushing certain recyclable containers, according to one embodiment of the invention;

FIGS. 7A-7B depict an assembly used for transporting crushed and/or shredded containers to a storage bin, according to one embodiment of the invention;

FIGS. 8A-8B depict an assembly for collecting recyclable containers for storage, according to one embodiment of the invention;

FIG. 9 depicts an exemplary data structure for storing information related to redemption activity and equipment, according to one embodiment of the invention;

FIG. 10 is a block diagram showing a system used for communicating information related to redemption activity, according to one embodiment of the invention;

FIG. 11 is a flowchart showing a process for encouraging redemption activity by consumers, according to one embodiment of the invention;

FIG. 12 is a perspective view of one embodiment of a densification device with shredding assemblies configured to form a first mesh;

FIG. 13 is a perspective view of the embodiment of FIG. 12 with shredding assemblies configured to form a second mesh;

FIG. 14 is a schematic view of the mesh shown in FIG. 12;

FIG. 15 is a plan view of a blade wheel used in the embodiments of FIGS. 12 and 13;

FIG. 16 is a perspective view of a shredding assembly shaft adapted to mate with the blade wheel shown in FIG. 15;

FIG. 17 is a perspective view of a chute between the conveyor path and densification device of one embodiment of the invention;

FIG. 18 is a perspective view of one embodiment of a system that includes three different types of densification modules; and

FIG. 19 is a perspective view of one densification module and the back end module of the embodiment shown in FIG. 18.

### DETAILED DESCRIPTION

Applicants have appreciated that a system which may receive, identify and sort a wide range of recyclable containers in a short period of time, and which may allow a redemption center to provide accurate accounting information on the number and type of containers processed, is desirable. Accordingly, one aspect of the invention includes a system capable of receiving, identifying and sorting recyclable containers having any of numerous defining characteristics. For example, the system may receive, identify and sort containers based on their size, material, deliverability to a particular distributor, and/or any other desired characteristic(s). In one embodiment, the system is configured to receive any number of heterogeneous containers, load the containers individually on to a conveyor path, identify each container according to one or more defining characteristics, and convey each container to an appropriate densification device based on the defining characteristic(s). A container may be conveyed, for example, to a device which performs shredding, crushing, and/or processing in any other suitable manner. After densification, containers may be delivered to a bin or hopper for storage before containers are delivered in bulk to a distributor.

The defining characteristic(s) of a container may be identified in any suitable manner, as the invention is not limited in this respect. In one embodiment, a scanner may be employed to read identifying indicia on the surface of a container. For example, a bar code scanner may be employed to locate and read a bar code printed on a surface of the container. The bar code may provide any information which is useful for identifying the container. For example, the bar code may indicate the manufacturer of the container and/or the material from which the container is made. Based on information provided by the bar code, a container may be directed to an appropriate densification device. For example, a bar code on a container may indicate that the container is a twelve-ounce aluminum can, such that the system may cause the container to be conveyed to a device which is suitable for shredding aluminum cans.

Containers may be directed to a particular densification device based on any suitable characteristic(s). For example, the system may be configured to direct containers made from a particular material (e.g., plastic) to a first densification device, a second material (e.g., aluminum) to a second device, a third (e.g., glass) to a third device, and so on. Alternatively, the system may be configured to segregate containers according to manufacturer, so that all (or a portion) of the containers associated with a specific manufacturer may be directed to a specific densification device for destruction and commingling. Any suitable segregation technique may be implemented, as the invention is not limited in this respect.

The system may be configured to determine the characteristic(s) of a container in any of numerous ways. In one embodiment, the system may be equipped with a device which causes a container to rotate while it is in the purview of the scanner, so that the surface of the container may be presented to the scanner. Rotation of the container may be accomplished, for example, by means of a belt which forms a section of the conveyor path, such as a section which is in the vicinity of the scanner. In one embodiment, the belt may rotate rapidly in a direction which is the opposite of that in which the container otherwise travels along the conveyor path. For example, the belt may force the container in a direction which is opposite of the direction in which a pushing member propels the container along the conveyor path, such that the container is forced against the pushing member and forced to spin rapidly. This feature is described in greater detail below.

In one embodiment, the system may be equipped with a device which determines whether a container exceeds a predetermined size (e.g., circumference), so that a container which exceeds the predetermined size may be caused to rotate more rapidly than a smaller container while in the vicinity of a scanner. In this manner, the surface of the larger container may be more effectively presented to, for example, a bar code scanning device. If the device determines that a container exceeds a certain size, the device may communicate with a programmable logic controller (PLC) which may employ a processor to communicate instructions to a motor to speed up the rotation of the belt to facilitate the presentation of a greater amount of container surface area to the scanner.

The system may be equipped with any suitable number and type of densification devices. In one embodiment, individual devices may be provided for shredding aluminum cans, shredding plastic bottles, and/or shattering glass containers. Further, a plurality of a particular type of device may be provided, so that different size containers may be processed more effectively. For example, the system may include two separate shredding devices, including a first shredding device for smaller containers (e.g., twelve-ounce aluminum cans) and a second device for larger containers (e.g., two liter plastic bottles). The system may include any suitable number of densification devices, as the invention is not limited in this respect.

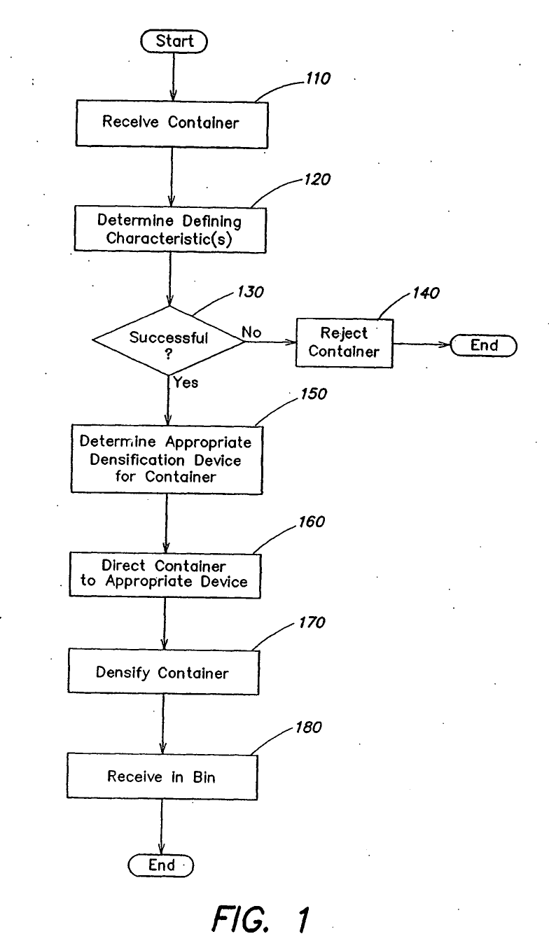

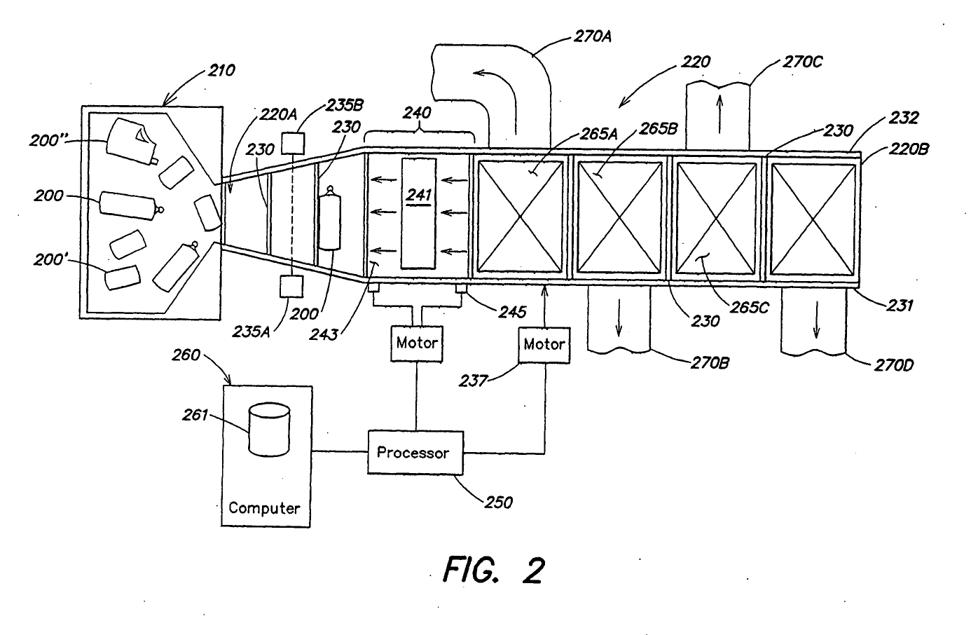

According to one embodiment, the system performs a process which is described below with reference to the flowchart of FIG. 1 and the top view of an exemplary embodiment of the system shown in FIG. 2. Referring first to FIG. 1, upon the start of the process, in act 110 a container is received by the system. A container may be manually or automatically fed to the system.

In one embodiment, a container may be presented manually (e.g., by an operator) to the system via intake platform 210 (FIG. 2). However, the invention is not limited in this respect, as any suitable intake mechanism may be employed. For example, a device may be employed to automatically select a container from a collection of containers, and feed it to the system for processing.

In the embodiment shown in FIG. 2, intake platform 210 is located at first end 220A of a stationary, longitudinally extending conveyor path 220. A container may be supported on path 220 while it is processed (e.g., presented to a scanner for identification, and conveyed to a densification device). In the embodiment shown, a container is discharged from path 220 at a position intermediate the first end 220A and second end 220B. Upon being caused to exit path 220, a container may be delivered for processing to a particular densification device, as described below.

In FIG. 2, three exemplary types of containers are shown, including bottle 200, can 200′, and jug 200″. However, the system is not limited to processing these types of containers, as any suitable container may be processed.

For purposes of illustrating the embodiment of the system shown in FIG. 2, the description below assumes that bottle 200 is formed of glass, can 200′ is formed of aluminum and jug 200″ is formed of a plastic material (e.g., high density polyethylene (HDPE) or polyethylene teraphthalate (PET)). It should be appreciated, however, that a container manufactured from any suitable material may be processed by the system, in any of numerous ways. For example, a given container, may be crushed, shredded, and/or processed in any other suitable manner.

Any of containers 200, 200′ and 200″ may be delivered from input platform 210 to first end 220A of path 220. For example, a container may be fed manually to path 220 (e.g., by an operator who places containers on path 220). In one embodiment, each container is fed to the system individually, although the invention is not limited in this respect. In the system of FIG. 2, an individual container may be fed to path 220 and may be caught and propelled by one of pushers 230. In one embodiment, pushers 230 may be a plurality of parallel spaced members positioned transverse 220 along its length. Each of pushers 230 may, for example, form a slat-like structure which is disposed generally upright with respect to path 220 as it travels along the length of the path, so as to propel a container along the path. In one embodiment, each pushers 230 is separated by an equal distance along the length of path 220.

Pushers 230 may be moved along path 220 (in a left-to-right direction as shown in FIG. 2) by drive means 231, 232, disposed on either side of path 220. Each of drive means 231, 232 may be, for example, endless belts, such as toothed belts or chains. Drive means 231, 232 may be mechanically interconnected so as to operate in a common fashion, or independent. In one embodiment, drive means 231, 232 may be operated by a motor 237.

In the embodiment shown, the portion of path 220 which is disposed near first end 220A forms an angle with the horizontal, such that as a container is loaded on to path 220, it is forced by gravity against pusher 230 as it proceeds along path 220, and is propelled up the incline defined by path 220 toward scanning station 240.

In one embodiment, a container may be propelled along path 220 past size detector 235. Size detector 235 may, for example, include light emitting device 235A and light receiving device 235B, each of which may be disposed at a predetermined height above path 220 in order to detect containers which exceed that height. In one embodiment, light projection device 235A may project, and light receiving device 235B may receive, a path of light. The path of light may be projected continuously or intermittently.

In one embodiment, if light receiving device 235B fails to receive a path of light projected by light emitting device 235A, size detector 235 may determine that a container traveling along path 220 is of sufficient size to block the path of light. If so, size detector 235 may communicate with processor 250 (e.g., via one or more cables or other suitable communication equipment), and processor 250 may in turn communicate with one or more components in scanning station 240. Processor 250 may be integrated with a programmable logic controller, although the invention is not limited in this respect. The use of information produced by size detector 235 is discussed further below with reference to act 120.

It should be appreciated that although the size detector 235 shown in FIG. 2 relies on the projection and receipt of a path of light to determine whether a container on path 220 exceeds a predetermined size, the invention is not limited in this respect. Any suitable mechanism may be employed for determining whether a container exceeds a predetermined size. For example, any suitable mechanical or electromechanical device may alternatively be employed. Referring again to FIG. 1, upon the completion of act 110, the process proceeds to act 120, wherein one or more defining characteristics of the container are determined.

In the embodiment shown in FIG. 2, scanning station 240 is employed to determine the defining characteristic(s) of a container. However, any suitable technique for determining the defining characteristic(s) of a container may be employed.

In the system of FIG. 2, scanning station 240 includes scanning device 241. In one embodiment, scanning device 241 includes a component which is configured for visually detecting bar code or other identifying indicia on the surface of the container, such as indicia which may be printed on a label adhered to the container. Scanning device 241 may be capable of detecting indicia which is located on the top, side or bottom of a container. Further, FIG. 2 depicts scanning device 241 as being positioned above path 220, scanning device 241 may be disposed in any suitable location, such as along one or more sides of path 220.

It should be appreciated that any suitable device may be employed for determining the identifying characteristic(s) of a container, and that any number and type of characteristics may be determined. For example, scanning device 241 may include a component which is capable of determining the structure and properties of a material or compound from which a container is made. For example, scanning device 241 may include one or more components configured for determining the characteristic(s) of a container via mass spectrometry, resonance imaging, optical recognition, resonance ionization mass spectrometry (RIMS), Radio Frequency Identification (RFID), and/or other techniques. The invention is not limited to any particular device or technique for identifying the characteristic(s) of a container, or the speed at which identification is performed.

In the embodiment shown in FIG. 2, scanning device 241 includes a bar code scanning device which is designed to locate and read bar code indicia which is printed on the surface of the container. So that the surface of a container is effectively presented to scanning device 241 for inspection, in the embodiment shown, scanning station 240 includes a rotating belt 243. Belt 243 may be driven by motor 247 and/or any other suitable means. In the embodiment shown, motor 247 causes belt 243 to rotate in a direction which is opposite to the direction in which container 200 is propelled by pusher 230 along path 220 (i.e., belt 243 rotates right-to-left, as designated by the arrows shown in FIG. 2). Belt 243 may be formed of a material which creates sufficient friction so that both round containers and non-round containers (e.g., squared gallon jugs) are forced to rotate while in scanning station 240. As such, the system may be capable of processing containers having any of numerous shapes. However, the system is not limited to such an implementation, as belt 243 may alternatively be formed of a material which creates insufficient friction for causing non-round containers to rotate. In this embodiment, non-round containers may be fed to path 220 such that identifying indicia (e.g., a bar code) are on the surface which faces scanning device 241.

Scanning device 241 may be capable of inspecting a container's surface for only a limited “scan area,” defined by the length along path 220 bounded by reference numeral 240. For example, many bar code scanners require that a bar code be presented to the scanner within a limited area in order for the bar code to be effectively read. Consequently, in one embodiment, belt 243 is caused to rotate at a speed sufficient to cause the entire surface of most containers (defined by the circumference of the largest of those containers) to be presented to device 241 for scanning. A constant rotation of belt 243 at a higher speed may not be desirable, because faster rotation may make the system more costly to operate. However, at a slower rotation speed, larger containers may not be rotated fast enough for their entire surface to be presented to the scanner.

To balance these concerns, when size detector 235 detects that a larger container is approaching the scanner, size detector 235 communicates with processor 250, which may in turn instruct motor 247 to accelerate when container 200 arrives at scanning station 240, and decelerate to its normal rotation speed after a predetermined period (e.g., the period required for the container to pass the scan area). As such, the surface of larger containers may be more effectively presented to the scanning device, without incurring appreciably higher operating costs.

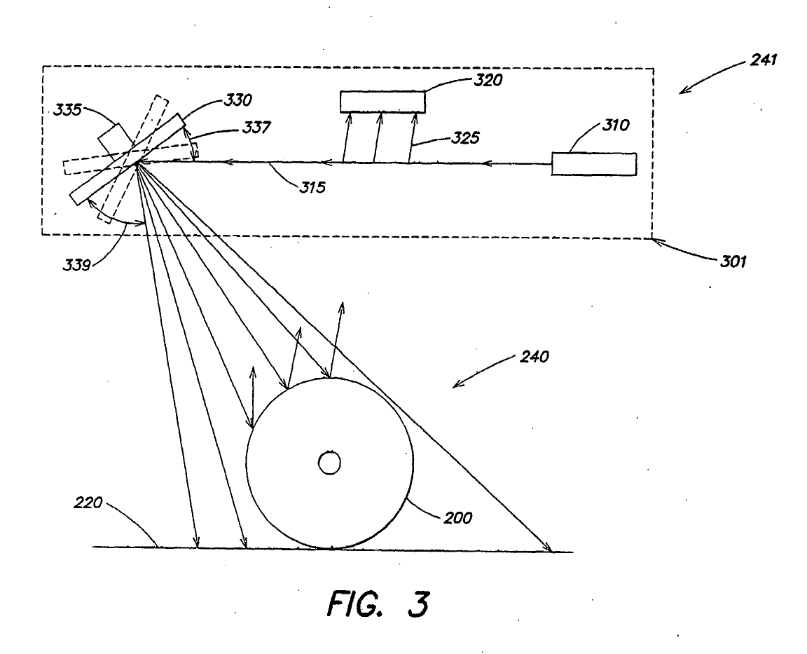

An exemplary embodiment of scanning device 241 is shown in FIG. 3. In the embodiment shown, scanning device 241 includes casing 301, which holds light emitting element 310 and light receiving element 320. Casing 301 is exposed to path 220 so that light projected by light emitting element 310 may irradiate scanning station 240 on path 220. In particular, light 315 projected by light emitting element 310 is reflected from mirror 330 (mounted on shaft 335) toward container 200 in scanning station 240, and then light 325 is reflected from container 200 toward light receiving element 320.

In one embodiment, mirror 330 is mounted on shaft 335 in a manner such that the rotation of shaft 335 will cause angle 337 to change over time. That is, the rotation of shaft 335 may cause mirror 330 to oscillate slightly, as indicated by the dotted lines in FIG. 3. As a result of the oscillation, the angle 339 at which light 315 is reflected from mirror 330 toward path 220 changes over time, such that a greater scan area is produced in scanning station 240 than if mirror 330 were mounted in a stationary position. As such, the probability that indicia on container 200 is presented within the scan area may be increased. For example, reflection of light 315 over a wider area in scanning station 240 increases the probability that the portion of the surface of container 200 on which indicia is printed will be presented to light receiving element 320 while container 200 is rotated in the scan area.

Any of numerous techniques may be employed to produce an oscillation of mirror 330. For example, an oscillation may be produced by a magnet, mounted to mirror 330, to which alternating currents are applied on a predetermined cycle.

In the embodiment shown in FIG. 2, information provided by scanning device 241 may be used to determine the defining characteristic(s) of the container. For example, information read from the surface of the container may be communicated from scanning device 241 to computer 260 to identify the defining characteristic(s) of the container. For example, information read from the surface of the container may be compared to information stored in electronic file storage 261. For example, electronic file storage 261 may maintain an association between certain bar code information (or a derivative thereof) and the size, manufacturer, material and/or other characteristics of particular containers, such that a comparison between information read from the surface of the container and information stored in electronic file storage 261 may allow one or more characteristics of the container to be ascertained. Based on the ascertained characteristic(s), computer 260 may communicate instructions to processor 250 for conveying the container along path 220, as described in greater detail below with reference to acts 140 and 150.

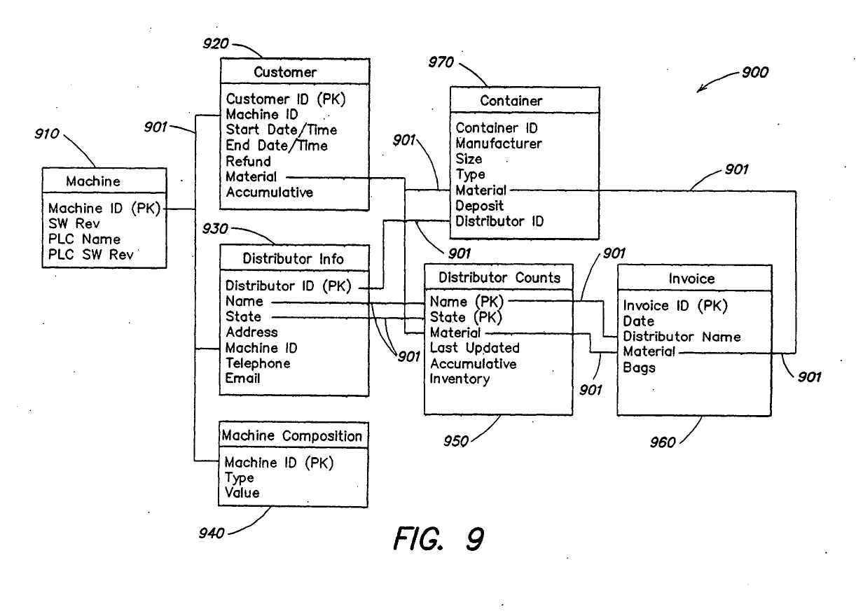

The information which may be stored in electronic file storage 261 is described in greater detail below, with reference to FIG. 9.

Referring again to FIG. 1, upon the completion of act 120, the process proceeds to act 130, wherein a determination is made as to whether the characteristic(s) of the container have been determined successfully. For example, it may be determined in act 130 whether scanning device 241 was able to successfully locate a bar code on the surface of container 200, and/or if the bar code information read by scanning device 241 was compared (e.g., matched) successfully to data stored in electronic file storage 261. If it is determined that the defining characteristic(s) of the container were not determined successfully, the process proceeds to act 140, wherein the container is rejected. In one embodiment, the container 200 may be caused to exit path 220 and may be directed to a reject bin. An exemplary technique for causing a container to exit path 220 is described with reference to act 170 below. Upon the completion of act 140, the process completes.

If it is determined in act 130 that the defining characteristic(s) of the container have been determined successfully, the process proceeds to act 150, wherein an appropriate densification device for the container is determined. In one embodiment, computer 260 may store an association between specific defining characteristic(s) and specific densification devices in electronic file storage. For example, computer 260 may store an association between containers made from a specific material and a particular densification device. For example, containers made from a first material may be directed to a first densification device, containers made from a second material may be directed to a second device, and so on. Alternatively, computer 260 may store an association between containers having a particular size and a particular densification device. For example, containers having a first (e.g., smaller) size may be directed to a first densification device, while containers having a second (e.g., larger) size may be directed to a second device, and so on. Based on the association, computer 260 may communicate instructions to processor 250 to cause the container to be directed to a specific device.

Upon the completion of act 150, the process proceeds to act 160, wherein the container is directed to a specific densification device. This may be accomplished in any of numerous ways. In one embodiment, processor 250 may receive instructions from computer 260, and may communicate with one or more components located along path 220 at specific junctures to cause a container to be directed to an appropriate densification device. For example, processor 250 may cause container 200 to be propelled along path 220 by a pusher 230 until the container reaches a specific gate (i.e., one of gates 265A-265D), at which time processor 250 may communicate with the appropriate gate to cause container 200 to exit path 220, such that the container may be delivered to a particular densification device.

In one embodiment, computer 260 stores additional information which may be used to determine the device to which a container is directed. For example, computer 260 may store an indication of the status of particular densification devices on the system, and this indication may influence the device to which a container is directed. For example, computer 260 may store an indication that the device corresponding to gate 265B is malfunctioning. As a result, computer 260 may communicate instructions to processor 250 to cause a container which would otherwise be directed to the malfunctioning device to be directed to another device (e.g., the device corresponding to gate 265C). Any suitable information may be stored and employed in any suitable fashion to determine the device to which a container is to be directed.

In the embodiment shown in FIG. 2, one or more of gates 265A-265D may form a “trap door” in the floor formed by path 220, such that upon actuation of a gate a container may be forced by gravity to exit path 220 and fall into a conduit (e.g., a chute) through which the container is delivered to a particular densification device.

In one embodiment, the actuation of a gate 265 may be influenced by whether scanning device 241 and/or size detection device 235 had previously determined that the container exceeds a predetermined size. For example, if the container exceeds the predetermined size, the gate may be held in an open position for a longer period than normal to allow the container to escape path 220 completely before gate 265 is closed. Other techniques may also, or alternatively, be employed to ensure that a container escapes path 220 before a gate is closed. For example, in one embodiment, the system may be equipped with a device for forcing a jet of air toward the container from above path 220 as gate 265 opens, so that the container is forced downward through the opening more quickly. Any of numerous techniques may be employed.

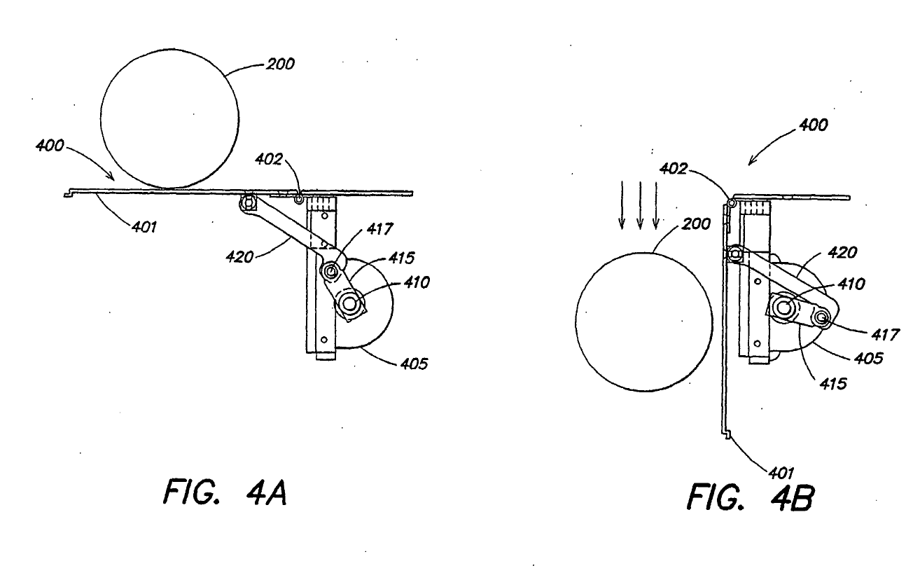

FIGS. 4A-4B show an exemplary embodiment of a trap door exit in further detail. FIG. 4A shows the exemplary trap door exit in a closed position, and FIG. 4B shows the exemplary trap door exit in an open position. Exit 400 includes door 401, which forms a portion of conveyor path 220 when in a closed position. Door 401 is operable by rotary actuator 405. In order to communicate instructions to rotary actuator 405, processor 250 may be connected via wires or other suitable communications medium (not shown).

Door 401 is attached via link 420 and clevis 415 to a shaft 410 provided on actuator 405. While clevis 415 is fixedly attached to shaft 410, such that a rotation of shaft 410 will cause a corresponding change in position of clevis 415, link 420 is attached to clevis 415 so as to allow link 420 to rotate with respect to a pivot point defined by hinge 417.

As shown in FIG. 4B, when processor 250 communicates instructions to actuator 405 to cause container 200 to exit path 220, actuator 405 causes shaft 410 to rotate in a clockwise direction. Clevis 415 also rotates accordingly, thereby exerting a force on link 420 via hinge 417 and causing door 401 to be pulled downward. More particularly, door 401 rotates about hinge 402. As door 401 moves downward, container 200 is caused by gravity to drop into an exit path (e.g., one of paths 270A-270D shown in FIG. 2) toward an appropriate densification device.

It should be appreciated that the invention is not limited to employing a trap door to deliver a container to a densification device. Any suitable mechanism or technique for causing a container to exit path 220 and be delivered to a densification device may be employed.

In one embodiment, gates 265A-265D are disposed along path 220 at known positions, and drive means 231, 232 propel pushers 230 along path 220 at a known speed. Because the speed of the drive means and the position of the gates is known, the system may track the progress of a pusher 230 (and thus a container propelled by the pusher) along path 220. For example, processor 250 may track the position according to a time period which elapses after the pusher/container exits scanning station 240. In one embodiment, path 220 may be slightly inclined so that end 220B resides at a slightly higher elevation than end 220. As a result, gravity may force a container to rest against a pusher as it is propelled along the path, and its position may be more precisely known.

In one embodiment, one or more sensors (not shown in FIG. 2) may also, or alternatively, be implemented proximate gates 265A-265D to determine when a particular pusher arrives at a gate. For example, a sensor implemented several inches before gate 265B along path 220 may detect that a particular pusher has arrived at gate 265B.

As such, the arrival of a particular pusher at a particular gate may be determined based on the physical presence of a pusher as detected by one or more sensors, a time period which elapses after a pusher exits the scanning station, both of these indications, or via any other suitable technique.

If gate 265B corresponds to the particular densification device to which the container is to be directed, processor 250 may cause gate 265A to be actuated to cause the container to exit path 220 and be delivered to the device. In one embodiment, one or more additional sensors may be implemented proximate gates 265A-265D to determine when a pusher has moved past a particular gate. For example, a sensor may be implemented several inches after gate 265B along path 220 to detect that a particular pusher has moved past gate 265B.

Using this technique, processor 250 may actuate any of gates 265A-265D to cause a container to exit path 220 and be delivered to a particular densification device. For example, if it is determined in act 150 (while a container is located within scanning station 240) that the container should be directed to the densification device associated with gate 265C (i.e., along path 270C), then in act 160, at the appropriate time and/or when the presence of the pusher propelling the container is detected proximate gate 265C, processor 250 may cause gate 265C to be actuated to deliver the container along path 270C to the selected device.

In one embodiment, gates 265A-265D are separated along path 220 by a distance which is less than the distance that separates pushers 230, to balance concerns relating to system effectiveness and size. For example, system effectiveness with regard to determining container characteristics may be improved by maximizing the length of scanning area 240, so as to keep a container within the scanning area for a greater amount of time and thereby increase the probability that the defining characteristic(s) of the container are determined. The distance between pushers 230 may approximate the length of scanning area 240 because the system may be capable of processing only one container within scanning area 240 at a time. Thus, it may be advantageous to maximize the distance separating the pushers. However, it may not be advantageous to separate gates 265 by such a large distance because this may cause path 220 to be lengthened, thereby unnecessarily increasing the size of the system.

It should be appreciated that the system is not limited to tracking the location of a container using the above-described devices and techniques, as any suitable device(s) and/or technique(s) may be employed. For example, an indexing scheme or encoding device may be implemented.

In one embodiment, if a container is rejected in act 140, then gate 265A may be actuated when the container is propelled thereto, and the container may be directed down path 270A (e.g., to be returned to an operator).

It should be appreciated that although the system depicted in FIG. 2 includes three separate paths associated with three different densification devices, any suitable number of paths and/or devices may be provided, as the invention is not limited in this respect. For example, two paths may lead to a single device, or vice versa. In addition, all paths on the system may not lead to a densification device. For example, one or more paths may be configured to receive a container that could not be directed to a densification device for some reason, such as because the gate 265 corresponding to the device malfunctions.

Upon the completion of act 160, the process proceeds to act 170, wherein the container is processed by a densification device. In one embodiment, upon actuating the gate 265 associated with the device, processor 250 communicates with the device to start a motor forming a component of the device. Consequently, the device may be started as the container travels down one of paths 270 toward the device, such that the container may be processed immediately upon its arrival at the device. The motor may alternatively be started at another suitable time, such as a time defined with reference to the opening of a gate 265. As a result, the cost of operating the system may be reduced, by eliminating the cost associated with running the motor continuously while the machine is in operation.

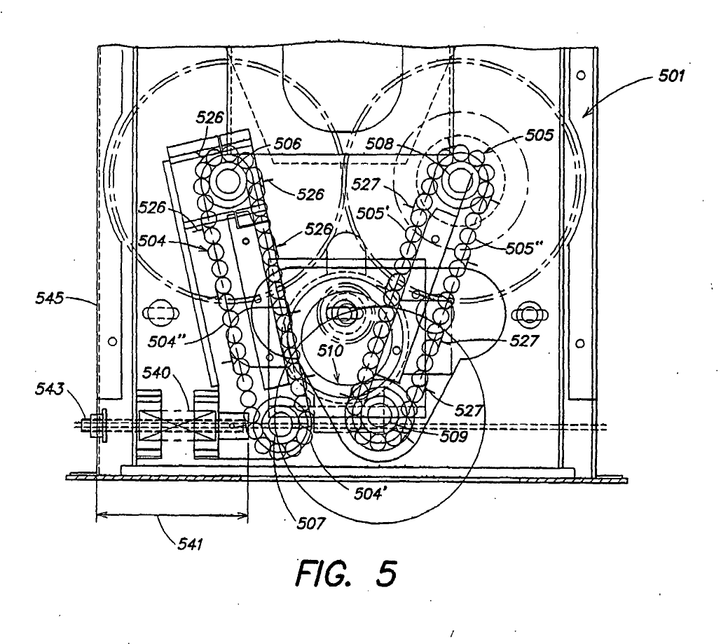

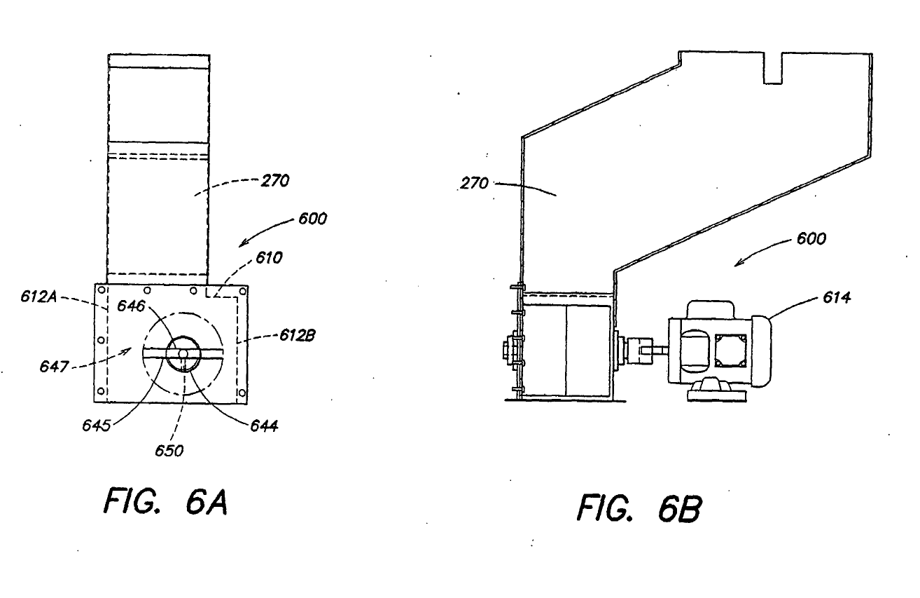

As discussed above, any number and type of densification device(s) may be employed on the system. FIGS. 5, 6A-6B, and 12-13 depict three exemplary devices which may be implemented. Specifically, FIGS. 5 and 12-13 depict exemplary devices which may be employed to shred plastic or aluminum cans or bottles, and FIGS. 6A-6B depicts an exemplary device which may be employed to crush glass containers.

FIG. 5 depicts a device that may, for example, be particularly useful in crushing a plastic container having a stiff neck portion. In particular, the neck portion of some plastic bottles can be so stiff that the motor included in some conventional devices may not be powerful enough to crush the bottles and force them through a narrow opening defined by the device into a storage bin. As a result, these bottles may become stuck in the opening, causing the devices to stall or experience other malfunctions. Other containers may also cause these and other device malfunctions.

Exemplary device 501 includes a pair of mutually inclined endless belts (e.g., chains) 504, 505. The belts have bottle-engaging front sides 504′ and 505′, and rear sides 504″ and 505″, respectively. The belt 504 may be suspended by means of rollers 506, 507, which may be driven by a motor (not shown) and which may force belt 504 to rotate in a clockwise direction as viewed in FIG. 5. Similarly, belt 505 may be suspended by means of rollers 508, 509, which may also be driven by a motor (not shown) and may force the belt 505 to rotate in a counter-clockwise direction as viewed in FIG. 5. A bottle arriving to be processed by device 501 is thus forced toward opening 510 by the rotation of belts 504, 505.

Belts 504, 505 may each be provided with a plurality of chain attachments (e.g., studs) 526, 527, respectively. Chain attachments 526, 527 may be formed of any suitable material (e.g., steel or other metal), and may be embedded or inserted in the belts 504, 505 so as to engage and puncture a container as it is forced toward opening 510 by the rotation of belts 504, 505.

In one embodiment of the invention, when a container enters opening 510 and is gradually subjected to increasing pressure, as roller 507 is forced slightly to the left (about a pivot point defined by roller 506) to provide sufficient space for the container to exit the device at the lowermost end of opening 510, the motion of roller 507 is opposed by resilient mechanism 540. Resilient mechanism 540 may include a spring, or any other mechanism suitable for opposing the motion of roller 507.

Any suitable amount of opposing force may be applied by resilient mechanism 540. For example, resilient mechanism may apply an amount of force which is predetermined based on a known stiffness of a particular container, or based on any other suitable parameter.

As a result of the placement of resilient mechanism 540, roller 507 may be allowed to move about a pivot point defined by roller 506, such that opening 510 is allowed to widen to accommodate more rigid containers when necessary. As a result, a device malfunction, such as stalling of the motor driving rollers 506-509, may be prevented, while an amount of force sufficient to puncture and crush more pliable containers may be applied.

In one embodiment, the position of, and force applied by, resilient mechanism 540 may be adjusted. For example, a screw 543 may be provided for adjusting the distance 541 from side wall 545 that resilient mechanism 540 extends, thereby adjusting the angular position of belt 504 relative to the pivot point defined by roller 506.

The use of a resilient mechanism 540 may allow a less powerful motor to be employed, thereby reducing the cost associated with operating the system. For example, without a resilient mechanism implemented, a less powerful motor may be prone to stalling or other malfunctions when stiffer articles are introduced into opening 510. With a resilient mechanism, however, a device having a less powerful motor may successfully process stiffer articles, without incurring the higher energy costs associated with more powerful motors.

FIGS. 6A-6B depict a device 600 which may be employed for the densification of glass containers according to one embodiment of the invention. Specifically, FIG. 6A provides a front view of the device, while FIG. 6B provides a side view. Device 600 includes a casing 610 which is open at the top and bottom and defined by side walls 612. A shaft 644 is mounted for rotation, and is driven by motor 610.

In the exemplary device shown, shaft 644 includes a single cavity 646 which is suitable for installation of a steel member 645. In other embodiments, a plurality of cavities 646 may be formed in shaft 644. Further, cavities may be provided in any suitable configuration. For example, an exemplary implementation may include two cavities formed in shaft 644 at right angles to each other.

In one embodiment, member 645 has a generally cylindrical shape. When installed in cavity 646 of shaft 644, member 645 extends from the shaft such that, as the shaft 644 rotates, the member rotates about the shaft. Member 645 is configured such that when it rotates about shaft 644, it does not contact side walls 612. In the embodiment shown in FIG. 6A, shaft 644 and member 645 rotate in a clockwise direction at high speed (in one embodiment, at approximately 1,200 revolutions per minute).

In operation, a glass container 200 descends into casing 610 via exit path 270, entering casing 610 through an opening at the top. Shaft 644 is disposed closer to side wall 612B than side wall 612A so that container 200 tends to fall into opening 647. As it does so, it is contacted by rotating member 645. The member 645 is configured to place substantial stress on localized portions of the container, such that the container will tend to break easily. In addition, the member rotates so rapidly, and in a direction that tends to keep container 200 within opening 647, that the member may contact container 200 multiple times. As such, container 200 tends to shatter into many small pieces. If multiple members 645 are implemented, this effect may be compounded.

In one embodiment, member 645 may be affixed within cavity 646 by means of a set screw (not shown) installed in cavity 650. Further, in one embodiment, a member may not be completely cylindrical, but rather may include one or more flat faces designed to accommodate the set screw. In the embodiment shown in FIG. 6A, because the cavity 650 is disposed parallel to the direction of travel of container 200, a flat face on member 645 may contact container 200 as it approaches opening 647.

The provision of one or more flat faces on member 645 may facilitate easier installation, a sturdier assembly, and easier maintenance of the member. For example, when significant wear is observed on one face of the member, the member may simply be turned over so that the opposing face is presented to containers entering the casing.

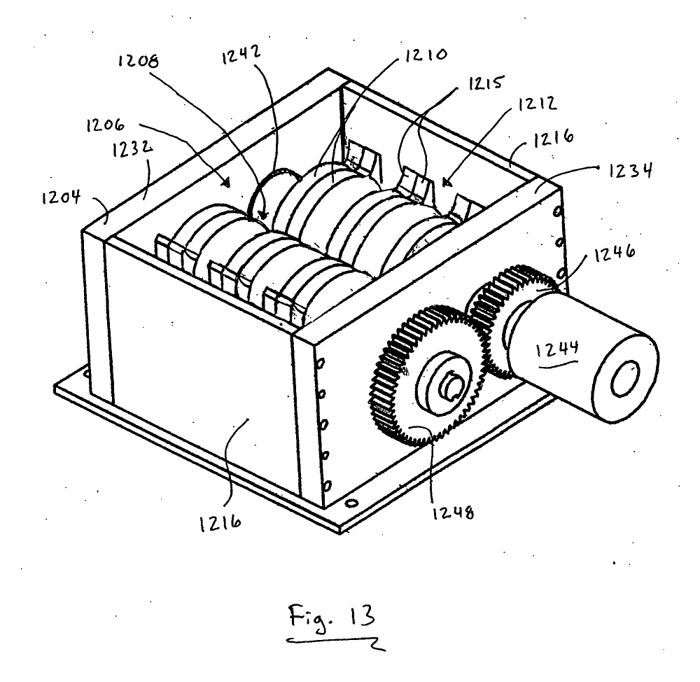

Another illustrative embodiment of a densification device is shown in FIG. 12. In particular, the embodiment of FIG. 12 may be useful for shredding plastic bottles and/or aluminum cans.

The densification device 1202 of FIG. 12 includes a housing 1204 that defines an internal densification area 1206 where plastic bottles and/or aluminum cans are received. Central to the densification area is a mesh 1208 defined by blade wheels 1210 of opposed shredding assemblies 1212. The shredding assemblies 1212 each comprise sets of blade wheels 1210 that rotate with respect to one another on motor driven shafts 1214 that extend, at least partially, through the densification area 1206. Blades 1215 of the blade wheels 1210 capture recyclable containers received in the densification area and pull the containers into the mesh 1208. As the containers pass through the mesh, they are shredded and densified into strips or flakes of material, which then fall into a bin or hopper, as discussed herein.

According to an illustrative embodiment of the invention, the densification device can be configured to accomplish different objectives, such as to produce different densities of recovered material or to accommodate different types of containers. By way of example, blade wheels 1210 may be mounted to the shafts 1214 in different patterns so as to create different meshes 1208 between the shredding assemblies 1212. As shown in the embodiment of FIG. 12, the blade wheels 1210 can be configured such that adjacent blade wheels 1210 of the same shredding assembly 1212 are each separated by a blade wheel 1210 of the opposed shredding assembly. Such a configuration produces very dense, flake-like recovered material and reliably renders barcodes, like those typically found on twelve-ounce aluminum cans and plastic bottles, unreadable when the device is constructed with the dimensions like those disclosed herein.

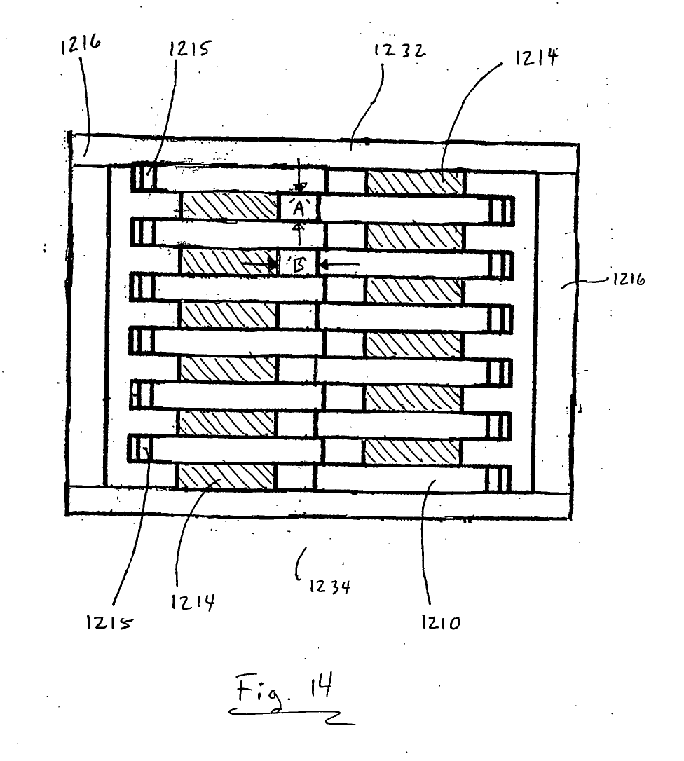

FIG. 13 shows components of the densification device of FIG. 12 reconfigured to create a coarser mesh 1208. The coarser mesh results in less dense recovered material than the configuration of FIG. 12, but may provide for faster recyclable container processing times. The blade wheels 1210 of the embodiment of FIG. 13 are mounted in pairs on each of the shredding assembly shafts 1214, such that adjacent pairs of blade wheels of a shredding assembly are separated by a pair of blade wheels of the opposed shredding assembly. The pattern of blade wheels in the embodiment of FIG. 13 effectively doubles the lateral spacing of a given mesh, as is described in greater detail below. However, this coarser mesh can also reliably render the barcodes typically found on twelve-ounce aluminum cans and plastic bottles unreadable when the device is constructed with the dimensions described herein, or with substantially similar dimensions.

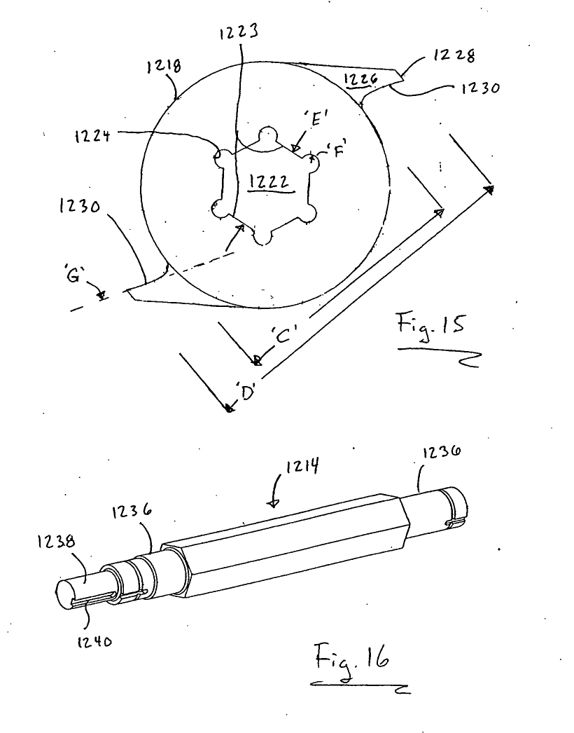

A schematic representation of the mesh of FIG. 12 is shown in FIG. 14. As used herein, the term “mesh” refers to the area defined by blade wheels of opposed shredding assemblies where recyclable containers are densified. A mesh can be generally characterized by lateral spaces, overlapped spaces, and blade configurations. As represented in FIG. 14, lateral spacing ‘A’ represents the width of a gap in the mesh, taken in a direction parallel to the shafts 1214, between blade wheels 1210 that lie immediately next to each other on the same shredding assembly 1212. Overlapped spacing ‘B’ represents the width of a gap in the mesh, taken in a direction orthogonal to the shafts 1214, between the outer peripheral surface 1218 of a blade wheel 1210 and the shaft 1214 of an opposed shredding assembly. Blade configuration refers generally to the shape of individual blades that extend from the blade wheels, and the overall configuration and number of blades that are present on the opposed shredding assemblies.

Two exemplary meshes are shown in FIGS. 12 and 13, and are represented schematically in FIG. 14, however, it is to be appreciated that other mesh configurations are possible, and may prove beneficial for particular applications. By way of example, shredding assemblies can be configured to provide a mesh with lateral spacing or overlap spacing that varies across the mesh. For instance, in one embodiment, blade wheels are arranged to create smaller lateral spaces near the housing walls 1232, 1234 to prevent recyclable containers from being lodged between the housing wall and a blade wheel 1210 during operation. Still, other arrangements are possible, as aspects of the present invention are not limited to those configurations that are illustrated in the figures or that are explicitly discussed herein.

FIG. 15 is a side view of the blade wheel shown in the embodiments of FIGS. 12 and 13. The illustrated blade wheel 1210 has a circular, outer perimeter 1218 of diameter ‘C’ with two blades 1215 extending therefrom to a diameter ‘D’. The blade wheel includes a central, hexagonally shaped aperture 1222 with spacing ‘E’ between opposed sides 1223 of the hexagon. The central aperture 1222 receives a shaft 1214 for mounting the blade wheel thereto.

As illustrated, the hexagonal aperture 1222 includes substantially circular interior corners 1224 of radius ‘F’ to help prevent stress risers that could damage the blade wheel 1210 or a mating shaft 1214.

Although other dimensions are possible, one illustrative embodiment of FIG. 15 has dimension ‘C’ equal to 5.0 inches, dimension ‘D’ equal to 7.0 inches, dimension ‘E’ equal 1.7 inches, and dimension ‘F’ equal to 0.2 inches. The blade wheel and blades themselves have a thickness of 0.7 inches that results in lateral spaces of 0.7 inches and overlapped spaces of about 1.4 inches when mounted on 1¾ inch shafts with centerlines spaced 4.8 inches apart from one another. It is to be appreciated that the blade wheel embodiment shown in FIG. 15, and the dimensions described above, are but one possible configuration, as aspects of the invention are not limited in this regard.

Blades can have different configurations to effect different densifications and/or forms of recovered material (e.g., more strip-like or more flake-like recovered material). The blades 1215 in the embodiment of FIG. 12 have the same width as the blade wheels 1210, taken in a direction parallel to the shafts 1214 (i.e., these blades are of a ‘full width’). Full width blades promote more flake-like recovered material, all else constant. In other embodiments (not shown), the side walls 1226 of the blades may taper at points closer to the distal end 1228 of the blade 1215. In an extreme case, the blade may taper to a point at the distal end. Tapered blades can promote the formation of more strip-like recovered material, as the tapered end can have a tendency to tear a recyclable container into strips, at least more so than full width blades.

The forward face 1230 of the blade 1215 can be angled to help grab recyclable containers received in the densification area 1206. By way of example, the face of the blade can be angled such that a line ‘G’ drawn parallel to the face, as shown in FIG. 15, passes behind the center point of the blade wheel. A forward face 1230 that is angled in this manner may also help the mesh produce finer recovered material, as blades of the opposed wheels tend to pull portions of the container away from each other during densification. It is to be appreciated that not all embodiments of the invention require blades with faces angled in this manner, or angled at all, as aspects of the invention are not limited in this respect.

Blade wheels 1210 can be mated to shafts 1214 in different orientations to create different meshes 1208. As shown in FIG. 12, similarly configured blade wheels 1210 are mounted to each shaft 1214 in the same orientation. This results in a mesh 1208 with a substantially aligned rows of blades 1215 extending in a direction parallel to the shaft 1214 that each grab and densify containers at the same time. Other embodiments may have blade wheels mounted to shafts at different angles with respect to one another to create a mesh with staggered blades that enter the mesh at different times. By way of example, the blade wheels 1210 illustrated in FIG. 15 may be angled at 60 degree increments with respect to one another on a hex-shaped shaft 1214, as the invention is not limited to the illustrated configurations.

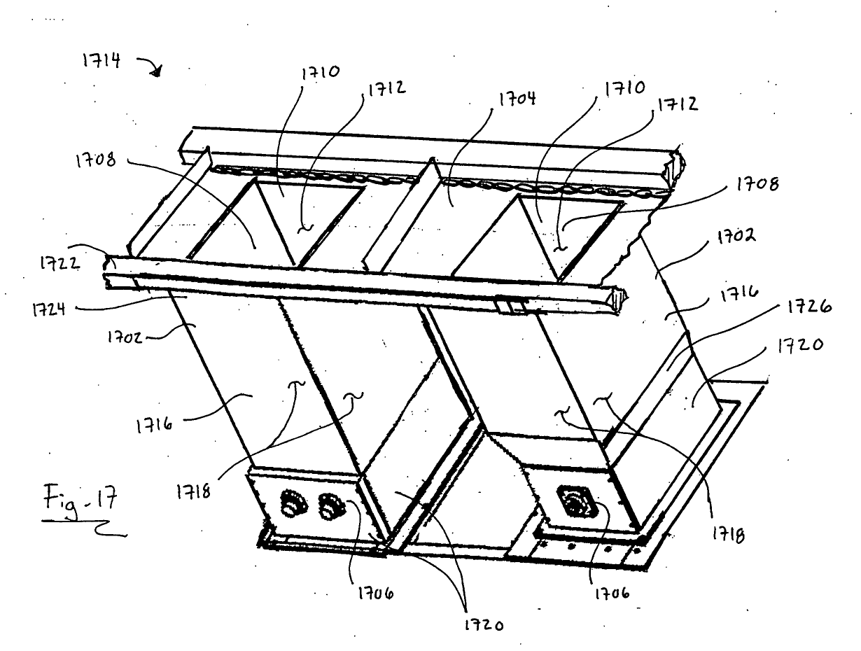

In one illustrative embodiment, the blade wheels can easily be removed and reinstalled for easy maintenance or reconfiguration of the densification device. FIG. 16 shows one embodiment of a shaft 1214 that is used in combination with the blade wheel(s) of FIG. 15 to promote rapid reconfiguration. As discussed above, the shaft 1214 has a central, hexagonal cross section that mates with the central aperture 1222 of the blade wheel 1210 shown in FIG. 15. The blade wheels are slid onto the shaft to create a stack of spaced blade wheels having a total stack width equal to the distance between front 1232 and back 1234 walls of the housing 1204. As is discussed herein, a removable wall of the housing that mates with an end of each of the shredding assemblies holds the blade wheels on the shafts.

The shaft of FIG. 16 has additional features for engaging other components of the densification device. End portions 1236 of the shaft 1214 may be rounded to provide a bearing surface that allows the shredding assemblies to rotate within the housing of the densification device. The shaft also has rounded surfaces 1238 for receiving various gears or other drive features of the shredding assemblies. In the illustrated embodiment, the shafts include keyways 1240 for mating with the drive 1246 and driven 1248 gears of the shredding assemblies 1212. It is to be appreciated that FIG. 16 shows but one shaft configuration, and that other types of shafts with different arrangements for mating with blade wheels fall within the scope of the present invention.

The housing 1204 embodiment illustrated in FIG. 12 is generally constructed as a four-sided box without a top or a bottom. Each of the front and back walls have apertures 1242 for receiving bearings which, in turn, receive the shafts 1214 of the shredding assemblies 1212. Side walls 1216 mate with the front 1232 and back 1234 walls to provide a protective enclosure where recyclable containers are densified. After recyclable containers pass through the mesh and are densified, the resulting recovered material falls through the bottom of the housing and into a bin or hopper.

The densification device housing can be configured to promote delivery of recyclable containers into the mesh of the densification area. By way of example, the spacing between the side wall 1216 of the housing and the peripheral surface 1218 of the blade wheels 1210 on each of the shredding assemblies may by sized to prevent recyclable containers from passing thereby. Recyclable containers that fall toward the side wall of the housing will not pass through the device. Instead, blades 1215 of the rotating shredding assemblies will bat the container about the densification area 1206 until the container is pulled into the mesh 1208 and is densified.

In one embodiment with blade wheels like those described above with respect to FIG. 15, the space between the outer, peripheral surface 1218 of the blade wheel and the housing sidewall 1216 is about 1.6 inches. This spacing has been found to prevent typical twelve-ounce aluminum cans and plastic bottles from passing from the densification area without entering the mesh of the densification device. It is to be appreciated that the spacing may be different in other embodiments, particularly those embodiments constructed for densifying different types of recyclable containers as the invention is not limited in this regard.

Embodiments of the housing also have features to promote easy reconfiguration and/or cleaning of the of the densification device. In the illustrative embodiment of FIG. 12, the front wall 1232 may be removed by removing a set of fasteners that hold the front wall in place. With the front wall removed, the shredding assemblies 1212 may be removed from the housing 1204 for cleaning or reconfiguring.

The shredding assemblies can be driven in different manners. In the embodiment illustrated in FIG. 12, one of the shredding assemblies is connected to an electric motor (not shown) through a flexible, reducer coupling 1244. The shredding assembly includes a drive gear 1246 (as illustrated, a 42 tooth spur gear) that, in turn, drives a larger diameter driven gear 1248 of the opposed shredding assembly (as illustrated, a 54 tooth spur gear).

Operating rotation speeds may vary for different applications, however, in one illustrative embodiment, the drive shredding assembly is connected to a three horse power electric motor through a 29:1 gearing reducer and rotates at about 30 rpm during operation. A densification device configured in this manner can densify up to 100 plastic bottles or aluminum cans per minute. Other drive configurations, operating speeds, and processing rates are also possible, as the present invention is not limited in this manner.

Embodiments of the present invention may include additional mechanism(s) or configurations for directing recyclable containers into a mesh for densification. As mentioned herein, one such mechanism includes a nozzle that blows a container toward a densification device. Another such mechanism is a movable rod configured to deform beverage containers that are present in the densification area. The applicant has appreciated that denting or creating a flat spot on at least a portion of the a substantially cylindrical recyclable container, like an aluminum can or plastic beverage container, can allow the blades of the shredding assemblies to more easily grab the recyclable container and draw it into the mesh. In one embodiment the mechanism comprises a movable rod that extends toward the mesh from above the densification area. When actuated, the rod moves downward toward the mesh to deform containers it contacts or to push the containers directly into the mesh. The rod then retracts to its rest position. Pneumatic, electric, or other types of actuators may be used to move the rod, as aspects of the invention are not limited in this respect.

The above described mechanism may operate according to different schemes. In one embodiment, the mechanism is actuated at regular intervals, such as every five seconds, whenever the densification device is in operation. In other embodiments, the mechanism may be actuated manually by depressing an activation switch whenever the operator perceives that a recyclable container is caught in the densification area of the device.

Other features may be incorporated into a system to help feed recyclable containers into the mesh of a densification device. It has been found that the weight of recyclable containers allowed to queue in the densification area can help press the containers through the mesh. To this end, in some embodiments recyclable containers are gathered in the densification area until a certain threshold stack height of containers is reached. The threshold height can have different values, such as 8 inches, 10 inches, 20 inches, and the like, depending on the application. The shredding assemblies are then actuated to densify the containers. Typically, once the stack of containers reaches the threshold height, the shredding assemblies will turn on for a standard period of time, such as 30 seconds, although other lengths of time or schemes are possible, as the invention is not limited in this respect.

Different mechanisms can be used to detect when the recyclable containers have reached the threshold height. In one embodiment, an optical sensor projects a beam across the densification area at a position consistent with the threshold height. After the beam is broken for a threshold period of time, such as five seconds, the shredding assembly is turned on. Requiring the beam to be broken for a threshold period of time can prevent the shredding assemblies from turning on when a recyclable container simply passes therethrough as it is deposited in the densification area.

Although some embodiments use optical sensors to detect the stack height of recyclable containers, as discussed above, it is to be appreciated that other types of detection devices may be used in other embodiments, as the present invention is not limited in this manner.

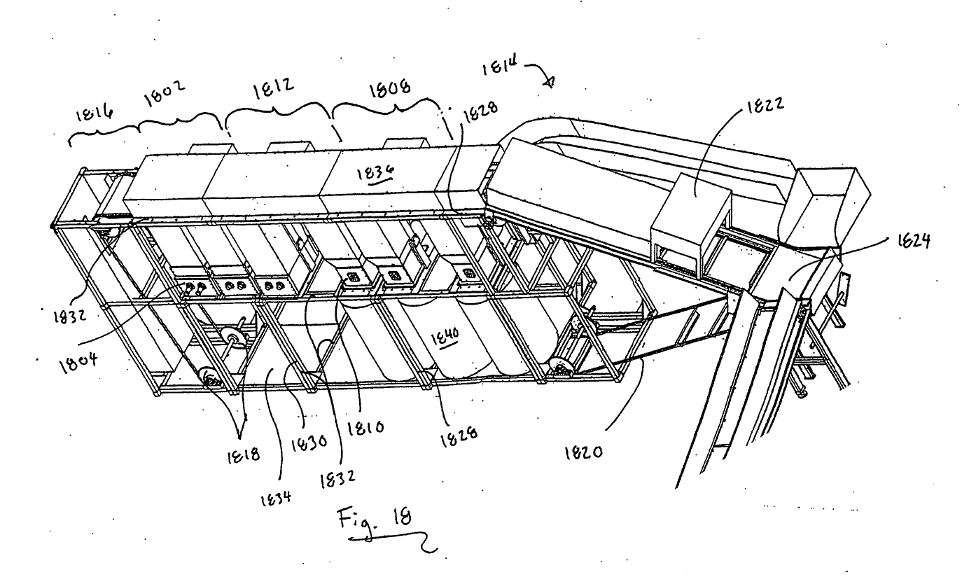

According to another embodiment, a chute 1702 between the conveyor path 1704 and the densification device 1706 is configured to direct recyclable containers into the densification device without additional moving components. By way of example, the illustrative embodiment of FIG. 17 shows two embodiments that each provide a path 1708, devoid of obstacles, between a densification device and an aperture of a trap door in a recycling system 1714 (trap door and actuating mechanism not shown in FIG. 17 for purposes of clarity). In this sense, a recyclable container that moves from the conveyor path 1704 is less likely to roll or skid along a surface 1712 of the chute, and thus attains a greater velocity before it reaches the densification device 1706. The greater velocity of the recyclable container promotes entry of the container into a mesh or similar features of a densification device.

Each embodiment of FIG. 17 includes a substantially rectangular housing 1716 defined by four walls 1718 that extends from the conveyor path 1704 to a densification device 1706. As illustrated, each chute is roughly 1½ feet by 2 feet in cross section and has a height of about 3 feet from the conveyor path to the top of the densification device housing. The walls 1718 of the chute are constructed of sheet metal, and are mated to housing walls 1720 of the densification device, each other, and an upper frame 1722 using conventional fasteners, such as threaded fasteners, welds, and the like. The upper portions 1724 of the chute walls define the aperture 1710 that receives recyclable containers from the conveyor path 1704 through a trap door. The chute embodiment on the left hand side of FIG. 17 provides a pathway to a densification device that has opposed shredding assemblies, like that shown in FIG. 12. The embodiment on the right hand side of FIG. 17 provides a pathway to a densification device with a rotating member, like that described with respect to FIGS. 6A-6B. It is to be appreciated that FIG. 17 illustrates but two possible embodiments of the invention, and that other embodiments may be constructed with different dimensions, in different configurations, and from different materials than those described above.

Several factors are considered in determining the cross-sectional size of the chute.

These factors include the size of the trap door that serves as a gate between the chute and the conveyor pathway, the size of the typical recyclable container or other material that will be recycled, and the overall size constraints of the system. Although not necessarily, the trap door, like that described with respect to FIGS. 4A-4B, may extend into the chute when opened. In such embodiments, the chute should be sized to accommodate the trap door at all points between its open and closed positions. Similarly, the chute should be substantially larger in cross-sectional size than the largest container that is to be densified by the system, such as by a factor of 1.5 or greater, to allow the container to reach the densification device unimpeded by excessive contact with the walls. Although several factors are listed above for consideration in sizing the cross-section of a chute, it is to be appreciated that other factors may be considered as well, as the above listing is not exhaustive.

Factors to consider in determining the height of the chute include the velocity with which a recyclable container is to impact the densification device, the size of the largest containers or other material to be densified, and the overall size constraints of the system. It has been found that a height of approximately 3 feet allows typical, twelve-ounce beverage containers to reach a velocity that promotes entry into a densification device, such as a mesh defined by opposed shredding assemblies. This height also has been found to promote reliable destruction of recyclable containers, such as glass bottles, that are dropped onto a rotating shaft, as is described with respect to FIGS. 6A-6B. It is to be appreciated, however, that other heights, such as 1 foot, 2 feet, 4 feet, and other distances may also produce adequate velocities to promote entry into a densification device for systems configured in different manners.

The embodiment of FIG. 17 provides a path devoid of obstacles by defining a vertical chute 1702 between the conveyor path 1704 and densification device 1706. As described above, such a configuration eliminates substantially non-vertical surfaces or obstacles that may slow a recyclable container that is moving toward a densification device. However, it is to be appreciated that the walls of the housing need not be absolutely vertical, and that some ricocheting or bumping between the walls and/or trap door and a container may not be disadvantageous. By way of example, in some embodiments, a trap door may be configured such that a recyclable container, once released, skids or rolls along the moving trap door. Such containers may subsequently fall with some horizontal velocity and may rebound off of a side wall of the chute on their descent toward the densification device without substantially reducing the acceleration of the container. Such contact with the trap door and side walls may not be substantial.

In other embodiments, the walls of the chute may be spaced closer toward one another at points closer to the densification device—forming a funnel shape along a portion of or the entire length of the chute. By way of example, the embodiment shown in the right hand side of FIG. 17 includes a funnel shaped portion 1726 that is directly above the densification device housing 1720. Here, recyclable containers may ricochet or rebound when moving downward, yet the configuration still promotes entry of the containers into the densification device. Such walls 1718 may be angled, with respect to vertical, by 10 degrees, 20 degrees, or even 30 degrees, as aspects of the invention are not limited in this respect.

In still other embodiments, the walls of the chute may be spaced further from one another at points closer to the densification device, forming essentially an inverted funnel shape. Such a shape, like others, may help prevent substantial contact between walls of the chute and recyclable containers. As used herein, the term “substantial contact” refers to contact that reduces the velocity of a recyclable container when it reaches the densification device by more than 20%, as compared to the velocity that the same container would reach if falling the same height without contacting any surfaces.

Densification devices of the system may be modularly configured such that they can be readily assembled into different system configuration. This can help a manufacturer meet the needs of different customers in a cost effective manner. By way of example, densification modules comprising two or more densification devices may be manufactured to be on hand for assembly into customizable, complete systems. Such modular systems may prove particularly beneficial when serving a diverse client base, such as one comprising customers of different sizes and/or from localities with different recycling regulations. Customers may process vastly different numbers of recyclable containers, and thus there is a need for machines with different throughput capabilities. Similarly, localities may have different regulations as to the type and form of recovered material that is acceptable, thus creating a need for systems with different combinations of densification devices.

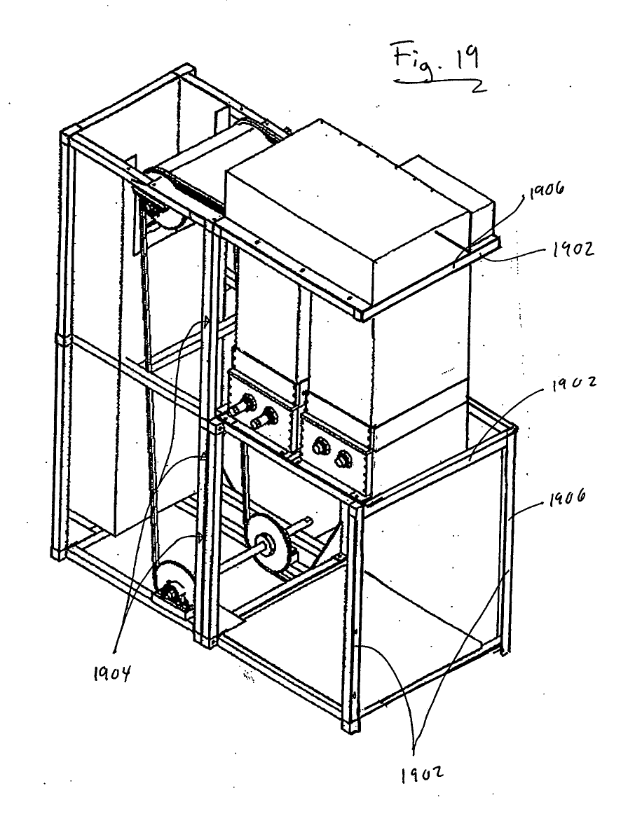

FIG. 18 depicts one illustrative embodiment of a system constructed with three different types of densification modules. A first 1802 of the modules shown in FIG. 18 has a pair of opposed shredding assemblies 1804, like those described with respect to FIG. 12. A third 1806 module includes a pair of densification devices with rotating members 1810, like those described herein with respect to FIGS. 6A-6B. A second module 1812 includes one each of densification devices described with respect to FIGS. 6A-6B and FIG. 12. The system also includes a back end module 1816 that has, among other features, return pulleys 1818 for the conveyor belt 1820. A front end module is located at the opposite end and includes a scanning station 1822, an intake platform 1824, and system controls, among other features.

Each of the modules shown in FIG. 18 includes a support frame 1828 to which various components of each module can be mounted. The frames are constructed of metal channels 1830 that are secured to one another with fasteners or welds, although other constructions are possible. The frames define mounting surfaces 1832 for densification devices 1804, 1810, the conveyor 1820, and a platform 1834 to hold a bin for receiving recovered material. A conveyor path cover 1836 is mounted to a top portion of the frame in each module. A space above the platform and beneath each of the densification devices 1804, 1810 is provided to accommodate bins or hoppers 1840. It is to be appreciated that the modules shown in FIG. 18 represent but one possible set of configurations, and that other configurations are possible.

Each of the modules shown in FIG. 18 include commonly designed mating faces, as shown in FIG. 19. That is, each densification modules and the back end module has an input face 1902 (i.e., the side of the module that receives containers from another module). Fastening features are used to mate the input face 1902 with a corresponding output face 1904 of any other densification modules or a front end module. In this regard, construction of a recycling system is simplified, regardless of the number and mix of densification modules that are incorporated into the system.

Embodiments of input faces and output faces may be mated to one another by different means. Holes may be drilled through frame members of the input and output faces to receive threaded fasteners to join modules together. One or both of the input and output faces may include alignment features, such as one or more dowels, that can be used to properly align modules with one another during assembly. In other embodiments, the input and output faces may simply provide flush surfaces 1906 that abut one another for subsequent welding together. Still, other approaches to securing the input and output faces to one another are possible, as the present invention is not limited to those discussed above.

Modules can be constructed with different types and/or combinations of densification devices, as discussed herein with reference to FIG. 18. In this regard, an appropriate mix of densification devices can be combined when manufacturing a recycling system. By way of example, one embodiment of a system may require four separate densification devices for densifying each of: clear glass containers, colored glass containers, plastic containers and aluminum containers. Here, the system may be constructed from two densification modules, a front end module, and a back end module. The first densification module may include two separate densification devices for smashing glass, like that described with respect to FIGS. 6A and 6B, one for colored and one for clear glass, and the second densification module may have a pair of densification devices with opposed shredding assemblies, like that described herein with reference to FIG. 12, one each for plastic containers and aluminum containers.

An alternate embodiment includes an additional densification module having different types of densification devices, like second module shown in FIG. 18. Another alternate embodiment includes two densification modules like the first module and two densification modules like third module of FIG. 18. Other illustrative embodiments of the invention may include still other numbers and types of densification modules, as aspects of the present invention are not limited in this respect.

Modules may be constructed with different lengths, since length can be altered without requiring changes of the mating features of an input face or an output face. By way of example, the first module shown in FIG. 18 has shorter length, taken between its input face and output face, than the second or third modules. Modules with shorter lengths can provide systems with overall smaller dimensions, and in this regard may be desirable for some applications. However, longer modules may also provide advantages. By way of example, longer modules can accommodate larger bins or hoppers to allow a system to collect a greater amount of recovered material before removal of recovered material is necessary.

Modular systems can be constructed in a relatively straightforward manner. Initially, the needs of a particular customer are assessed and the corresponding number and mix of modules is identified. According to one embodiment, construction of the system includes aligning the input face of a first densification module with the output face of the front end module. Appropriate fasteners are then installed to mount the front end module to the densification module. Additional densification modules are then mated together until the desired number and mix of densification modules is present. A back end module is then mated to the final densification module. Subsequently, an appropriately sized conveyor is threaded through each of the densification modules, the front end module and the back end module to complete the overall construction of the basic system structure. Controller logic, electrical wiring, and other system features are then installed to complete the construction of the system. It is to be appreciated that the aforementioned procedure is but one approach that may be taken to assemble a modular recycling system, and that aspects of the present invention are not limited to the above described approach.

Referring again to FIG. 1, upon the completion of act 170, the process proceeds to act 180, wherein the container, now processed by the densification device, is received in a bin. In one embodiment, upon the completion of act 170, processor 250 informs computer 260 that the densification of the container is complete. Computer 260 may store this information (e.g., in electronic file storage 261) so that accurate information on the number, weight and/or count of containers processed (or any other suitable information) by the system may be provided to interested parties, such as distributors.

Upon the completion of act 180, the process completes.

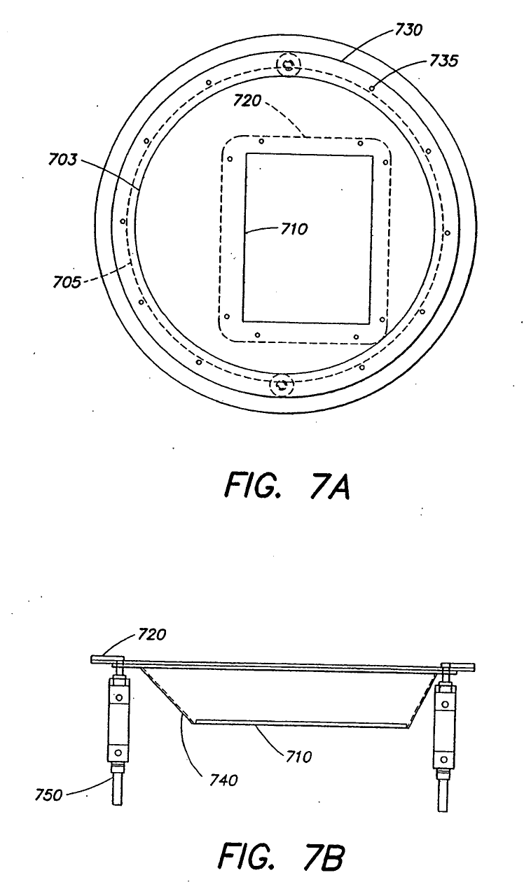

In one embodiment, glass containers processed by a densification device may travel through an airtight passage to a storage bin, such that operators of the system may not be exposed to airborne glass particles. An exemplary implementation of an airtight passage is depicted in FIGS. 7A-7B.

FIG. 7A shows a top view of the airtight passage. Specifically, dust cover 703 is mounted atop a bin (not shown, but having a periphery indicated by the dotted line at 705). In the embodiment shown, dust cover 703 is mounted to the bin via ring 730 and one or more screws 735. In one embodiment, one or more pieces of foam rubber may be provided to provide an airtight seal between the bin and ring 730. As an example, the foam rubber piece(s) may be cut to fit between ring 730 and the bin along its periphery 705.

Dust cover 703 includes cutout 710, which is provided roughly in the shape of the bottom of a casing of a densification device (e.g., casing 610, FIG. 6A). FIG. 7B shows that cutout 710 may have membrane 740 attached. Membrane 740 may be formed, for example, from a pliable, airtight material such as rubber, and may form a bellows between the bin and the densification device. Specifically, membrane 740 may be mounted fixedly via the attached bracket 720 to the bottom of a densification device casing (e.g., casing 610) via one or more fastening devices 750. As such, as glass particles travel from the casing to the bin, they will be conveyed though the airtight passage defined by membrane 740 and thus not discharged into the air. Because airborne glass particles may be hazardous to human health, the assembly of FIGS. 7A-7B may make the system safer to operate.

In one embodiment, a separate bin may be provided for each densification device implemented on the system. For example, if three densification devices are implemented, then three bins may be provided so that containers processed by each device arrive in a separate bin.

In one embodiment, one or more of the bins implemented in the system may have a plurality of segregated portions into which processed containers may be received. Further, the position of a bin may be adjustable so that densified containers are received in a first portion for a predetermined interval (e.g., for a specific time period, and/or until a fixed number of containers are directed into the first portion of the bin), and then the bin's position may be adjusted so that processed containers arrive in a second portion.

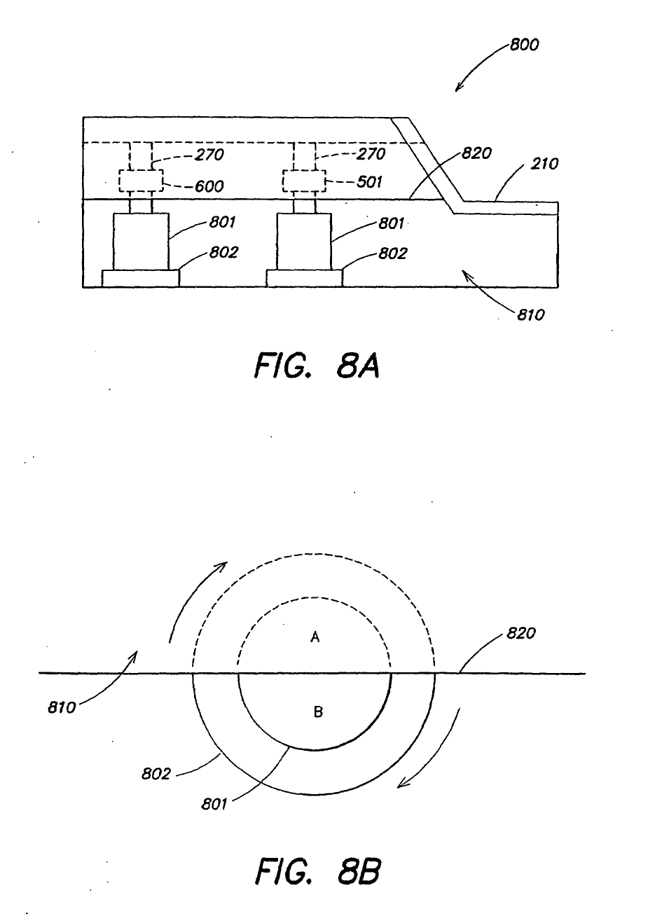

In the exemplary embodiment shown in FIGS. 8A-8B, cylindrical bins 801 are disposed partially within a cavity portion 810 of the system 800, such that a first portion A of bin 801 is obscured by wall 820, and a second portion B of bin 801 is exposed. Bin 801 is installed on rotating pedestal 802. When system 800 is operated, densified containers may be received in portion A of bin 801 for a predetermined interval. When the interval has elapsed, the pedestal 802 may be rotated (e.g., while the system continues to operate) in any suitable direction so that portion A becomes exposed and portion B becomes obscured by wall 820 in cavity portion 810. Consequently, any containers which may have been received in portion A during the operation of system 800 may be removed, and/or any other desired maintenance may be performed. For example, a container (e.g., a plastic bag, not shown) which had been installed to capture densified containers in portion A may be removed, while system 800 continues to receive densified containers in portion B. As a result, system 800 need not be shut down for bins 801 to be emptied.

In one embodiment, information on containers processed by the system may be stored in electronic file storage 261. For example, in one embodiment, data on containers processed may be stored in a database, such as a relational database.

A simplified version of a data structure used by a relational database management system (RDBMS) to support one or more of the functions discussed herein, is shown in FIG. 9. The data structure 900 of FIG. 9 includes machine table 910, customer table 920, distributor information table 930, machine composition table 940, distributor counts table 950, invoice table 960 and container table 970. It should be appreciated that the data structure shown in FIG. 9 is merely an exemplary embodiment, and that any of numerous data structures may alternatively be employed. For example, an alternative data structure may include different tables, or no tables at all, if not a relational database.

Each of the tables shown in FIG. 9 contains a number of named columns, including one or more which are designated as the primary key (denoted with “(PK)”), meaning that the one or more columns stores a unique value in each table row.

Some of the columns in each table are logically associated with (i.e., have a foreign key to) a column in another table; this association is indicated by the arrows 901. A logical association may be established for any of numerous reasons, such as to maintain relational integrity between the tables. For example, the machine table 910 has a column which stores a machine ID for each event. This machine ID has a foreign key to the machine ID in the customer table 920 (among others), such that that the customer table 920 may not store a machine ID that is not also stored in machine table 910. In this manner, consistency may be maintained between columns in various tables.

In the embodiment shown, machine table 910 stores information defining the software implemented on the machine (e.g., the software implemented by processor 250 and computer 260), customer table 920 stores information on one or more customers (e.g., a redemption center at which the machine is installed), distributor information table 930 stores information about particular distributors for which containers are processed and stored, machine composition table 940 stores information regarding the physical machine (e.g., its type and depreciated value), distributor counts table 950 stores information on the number and type of containers processed by the machine for each distributor, invoice table 960 stores information on invoices which maybe generated for reimbursement by a distributor for the processing of particular containers, and container table. However, any suitable information may be stored, as the invention is not limited in this respect.

In one embodiment, when a container is inspected in scanning station 240, information read from the container (e.g., provided by a bar code printed on its surface) is compared to information stored in container table 970. For example, scanning device 241 may communicate information which is read from container 200 to processor 250, which may then communicate information to computer 260 for comparison to table 970 in electronic file storage 261. For example, information read from container 200 by scanning device 241 may be communicated to computer 260 as a container ID, which may be compared by computer 260 to the container ID included in entries in table 970.

In one embodiment, if the container ID read from container 200 matches a container ID included in an entry in table 970, then container 200 is identified. Based on this identification, data in other columns in table 970 for the considered entry may be examined to determine the treatment of container 200 by the system. For example, data in other columns may be used to determine the densification device to which container 200 should be directed. For example, data in the “material” column may be examined to determine the material from which the container is made, which may determine the device to which container 200 is directed. As an example, if it is determined that the container is made of glass (i.e., the material column in table 970 contains an indication that the container corresponding to the considered container ID is made from glass), then container 200 may be directed to a glass crusher, such as device 600 shown in FIGS. 6A-6B. Container 200 may be directed to the device, for example, according to the techniques described above.

In one embodiment, when a container is recognized and processed by the system, accounting data related to the container may be updated in data structure 900. For example, data in the “distributor ID” column in the container table 970 may be examined and compared to the distributor ID column in the distributor information table 930 to obtain the distributor name and address information corresponding to the container. Using this information, data in the distributor counts table 950 and/or invoice table 960 may be updated. For example, data in the “accumulative” column in table 950 and/or the “bags” column in table 960 may be updated to reflect the receipt of container 200. As such, the system may store up-to-date accounting information related to the redemption activity for a known distributor.

In one embodiment, computer 260 may be equipped with one or more security features so that information stored in data structure 900 may not be modified (e.g., by an operator). For example, information stored in data structure 900 may be encrypted or stored in any other fashion which may dissuade tampering. As such, distributors may receive greater assurance that information received from a redemption center has not been modified fraudulently, such as to overstate the number or weight of containers processed.

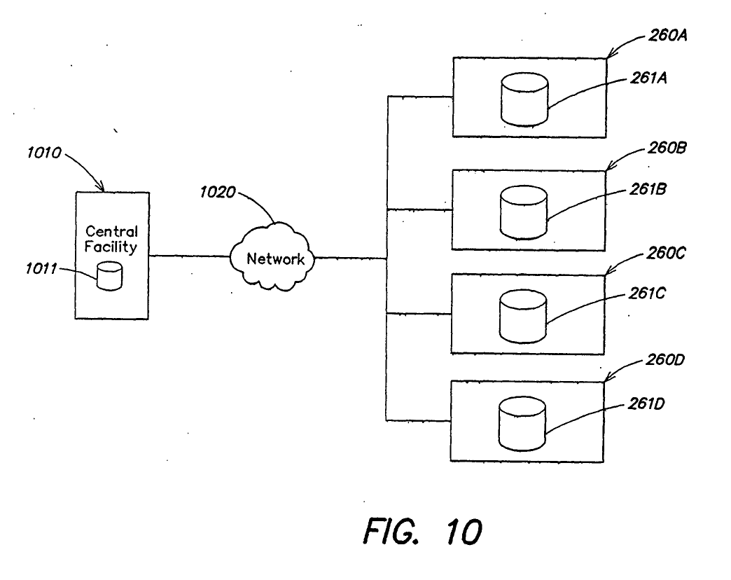

In one embodiment, information may be transferred between one or more computers 260 and a central facility. In one example, information collected by systems at multiple redemption centers, such as those which are implemented throughout a geographic region, may be communicated to a central collection facility for consolidation. In another example, information such as programmed instructions may be transferred from the central facility to one or more of computers 260. An exemplary implementation of this arrangement is depicted in FIG. 10.

FIG. 10 includes central facility 1010, which maintains electronic file storage 1011. Central facility 1010 communicates with computers 260A-260D via network 1020. Network 1020 may employ any suitable communications infrastructure and/or protocol(s). For example, network 1020 may include the Internet, a LAN, WAN, wireless network, or any combination thereof. In one embodiment, network 1020 may support bi-directional communication between central facility 1010 and any of computers 260, such that communication may be initiated by either of central facility 1010 or computer(s) 260.

Each of computers 260A-260D includes a respective electronic file storage 261A-261D. Each electronic file storage 261 may store information collected on redemption activity processed by a particular system, such as that which may be stored in data structure 900 (FIG. 9). Each of electronic file storage 261A-261D may also, or alternatively, store programmed instructions which may be executed, for example, to perform the processing techniques described above.

In one embodiment, information may be transferred between one or more of computers 260A-260D and central facility 1010. In one example, information on redemption activity may be uploaded from each of electronic file storage 261A-261D to electronic file storage 1011, so that activity occurring at multiple redemption facilities may be analyzed. For example, information related to a particular distributor captured at multiple redemption centers may be consolidated, and one or more reports may be generated from the information and delivered to the distributor. In another example, information may be downloaded from central facility 260 to one or more of computers 260A-260D. For example, central facility 1010 may periodically transfer software updates to each of computers 260A-260D for installation. Consequently, computers 260 may be more easily maintained.

In one embodiment, information related to redemption activity may be transferred to a transportable medium which may be used by a consumer for subsequent transactions, such as transactions with another business, thereby providing financial incentive for the consumer to redeem recyclable containers. For example, a redemption center may transfer information related to redemption activity to a computer-readable medium such as a credit or debit card, or a medium such as paper script. The medium may be used by the consumer to execute one or more subsequent transactions with one or more businesses, such as those which are business partners of the redemption center which issues the transportable medium. For example, an amount of deposit for containers returned by a consumer may be transferred to a debit card, and the consumer may then be credited for the amount of deposit when the consumer makes a purchase at a partner retail location such as a supermarket.

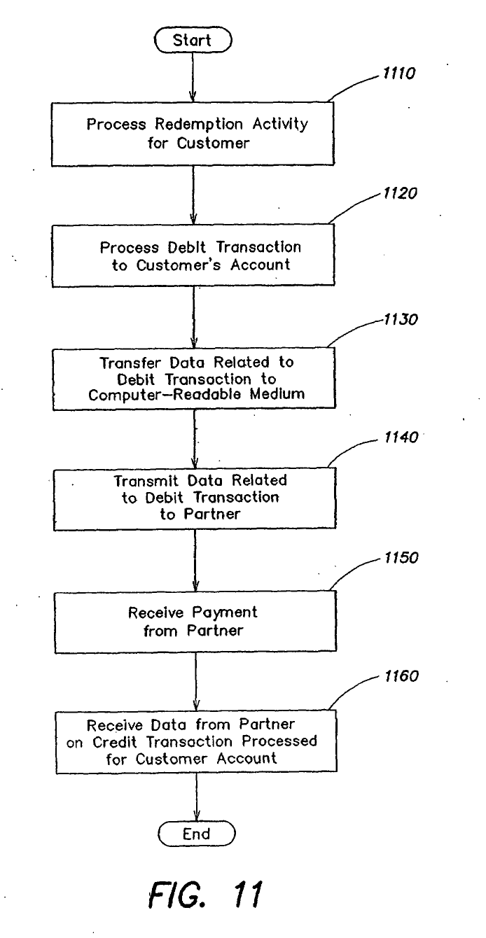

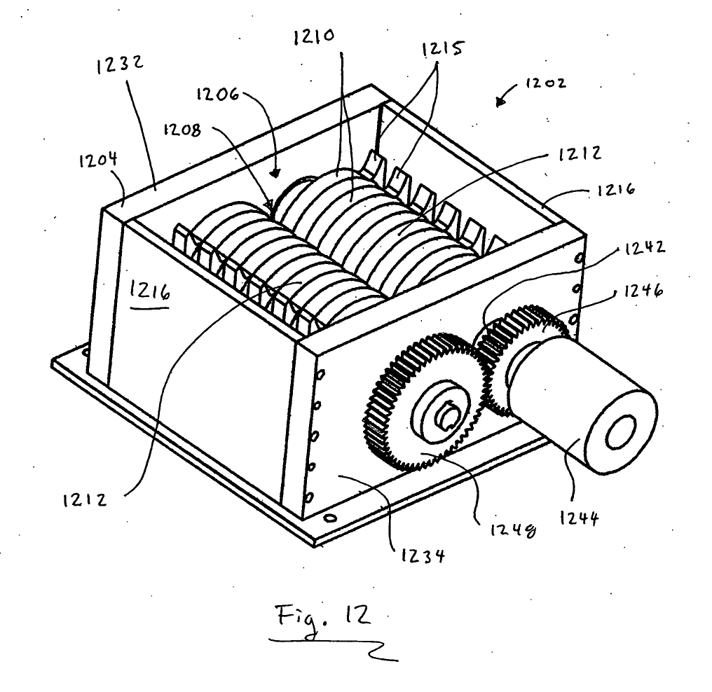

An exemplary process for encouraging consumer redemption activity by transferring information related to that activity to a transportable medium is described with reference to FIG. 11. Upon the start of the process of FIG. 11, redemption activity is processed for a customer in act 1110. This may be performed, for example, according to the techniques described above, such that one or more containers brought by the customer to the redemption center are each conveyed to an appropriate densification device, and information on processed containers is stored electronically (e.g., in data structure 900, FIG. 9). However, the invention is not limited in this respect, as redemption activity may occur in any suitable manner.

Upon the completion of act 1110, the process proceeds to act 1120, wherein the redemption center processes a debit transaction to an account held by the customer. This may be performed in any of numerous ways. For example, debit transaction may be posted electronically to an account maintained by the customer with the redemption center and/or a business partner of the redemption center. Information on the customer account may be stored, for example, in electronic file storage (e.g., in computer 260).

Upon the completion of act 1120, the process proceeds to act 1130, wherein data related to the debit transaction is transferred to a transportable medium. As an example, the data may be transferred to a medium such as a debit card, credit card, “key card,” paper script, or other suitable medium. If the data is transferred to a computer-readable medium, it may be stored, as an example, on a magnetic strip or the like. If transferred to paper, the data may be imprinted as a bar code or other coded information, or may simply be printed in alphanumeric text. The information may be suitable for reading by a computer (e.g., a bar code scanner or other scanning device) or human operator. Any suitable technique may be employed, as the invention is not limited to a particular implementation.

Upon the completion of act 1130, the process proceeds to act 1140, wherein data related to the debit transaction is transmitted to the business partner. The data may be transmitted to the business partner using any suitable technique, such as by sending a signal via a secure network. The data may help the business partner verify that the information encoded on the transportable medium is accurate when the customer presents the medium for cash or exchange. For example, when executing the transaction, the business partner may compare the information on the transportable medium to the information sent by the redemption center and stored electronically.

Upon the completion of act 1140, the process proceeds to act 1150, wherein payment is received by the redemption center from the business partner. In one embodiment, payment may be conditioned on a customer's presentation of the transportable medium for cash or exchange, and may be in full or partial satisfaction of the debit transaction processed by the redemption center. However, the invention is not limited in this respect, as any suitable reimbursement scheme may be implemented.

Upon the completion of act 1150, the process proceeds to act 1160, wherein information is received by the redemption center from the business partner related to one or more credit transactions processed for the customer account. The information may be for credit transactions which correspond to the debit transaction processed in act 1120. Receipt of this data from the business partner may allow the redemption center to gauge the success of efforts to encourage customers to redeem recyclable containers. For example, the data may allow the redemption center to measure the extent to which customers follow redemption activity with subsequent transactions with the business partner, providing an indication of whether customers find the transportable medium valuable and/or useful.

Upon the completion of act 1160, the process completes.

The above-described aspects of the present invention and exemplary embodiments thereof may be implemented in any of numerous ways. For example, any subset of the above-described features may be implemented in combination, as the invention is not limited to being wholly implemented.

Further, the above-discussed computer-implemented functionality may be implemented using hardware, software or a combination thereof. When implemented in software, the software code can be executed on any suitable processor or collection of processors, whether provided in a single computer or distributed among multiple computers. It should further be appreciated that any component or collection of components that perform the functions described above can be generically considered as one or more controllers or processors that control the above-discussed functions. The one or more controllers or processors can be implemented in numerous ways, such as with dedicated hardware, or with general purpose hardware that is programmed using microcode or software to perform their functions recited above.

In this respect, it should be appreciated that one implementation of the embodiments of the present invention comprises at least one computer-readable medium (e.g., a computer memory, a floppy disk, a compact disc, a tape, etc.) encoded with a computer program (i.e., a plurality of instructions), which, when executed on a processor, performs the above-discussed functions of the illustrative embodiments of the present invention. The computer-readable medium can be transportable such that the programs stored thereon can be loaded onto any computer system resource to implement the aspects of the present invention described herein. In addition, it should be appreciated that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

It should be appreciated that in accordance with several embodiments of the present invention wherein processes are implemented in a computer-readable medium, the computer-implemented processes may, during the course of their execution, receive input manually (e.g., from a user), in the manners described above. In particular, the processes may receive input from one or more GUIs. The GUI(s) may be implemented in any suitable manner, such as with a web browser or other interface. In this respect, the GUI(s) need not execute on a personal computer, and may execute on any suitably adapted device. Moreover, the computer-implemented processes may receive input from electronic processes, which may be provided without the active involvement of a human operator.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting. The invention is limited only as defined by the following claims and equivalents thereto.

What is claimed is:

1. A recyclable container densification device for rendering a bar code of a:
recyclable container unreadable, the device comprising:
a housing defining a densification area;
a first shaft that extends at least partially through the densification area;
a first set of blade wheels, each blade wheel of the first set having a peripheral surface with two or more blades extending therefrom and a central aperture for mounting each of the blade wheels of the first set to the first shaft, the first set of blade wheels mountable to the first shaft to form a first rotatable shredding assembly;
a second shaft substantially parallel to the first shaft and that extends at least partially through the densification area;
a second set of blade wheels, each blade wheel of the first set having a peripheral surface with two or more blades extending therefrom and a central aperture for mounting each of the blade wheels of the second set to the second shaft, the second set of blade wheels mountable to the second shaft to form a second rotatable shredding assembly, the first and second rotatable shredding assemblies positioned to form a mesh between the first and second sets of blade wheels; and
a motor for rotating the first and second shredding assemblies relative to one another to draw recyclable containers into the mesh for densification to render a bar code of the recyclable container unreadable.

2. The recyclable container densification device of claim 1, wherein the first and second shredding assemblies are configured such that the mesh has lateral spaces of about 0.7 inches and overlapped spaces of about 1.4 inches.

3. The recyclable container densification device of claim 1, configured to densify recyclable containers by a factor of 10 or more.

4. The recyclable container densification device of claim 1, configured to create flake-like recovered material from recyclable containers.

5. The recyclable container densification device of claim 1, wherein the first and second shredding assemblies are configured such that the mesh has lateral spaces of about 1.4 inches and overlapped spaces of about 1.4 inches.

6. The recyclable container densification device of claim 1, configured to densify recyclable containers by a factor of 2 or more.

7. The recyclable container densification device of claim 1, configured to create strip-like recovered material from recyclable containers.

8. The recyclable container densification device of claim 1, wherein the housing is configured to prevent containers from passing from the densification area without also entering the mesh.

9. The recyclable container densification device of claim 9, wherein the housing has side walls that are spaced from outer peripheral surfaces of the blade wheels by fewer than 1.8 inches to prevent containers from passing from the densification area without entering the mesh.

10. The recyclable container densification device of claim 1, wherein blades are full width blades.

11. The recyclable container densification device of claim 1, wherein the first and second shredding assemblies are configured to rotate at different speeds.

12. The recyclable container densification device of claim 1, further comprising:
a mechanism above the densification area that promotes easier feeding into the mesh.

13. The recyclable container densification device of claim 12, wherein the mechanism includes a rod that is moved toward the mesh to deform beverage containers.

14. The recyclable container densification device of claim 13, wherein the mechanism includes a sensor that actuates the first and second shredding assemblies once a threshold height of beverage containers is collected in the densification area.

15. A reconfigurable recyclable material densification device comprising:
a housing defining a densification area;
a first shaft that extends at least partially through the densification area;
a first set of blade wheels, each blade wheel of the first set having a peripheral surface with two or more blades extending therefrom and a central aperture for mounting each of the blade wheels of the first set to the first shaft, the first set of blade wheels mountable to the first shaft to form a first reconfigurable rotatable shredding assembly;
a second shaft substantially parallel to the first shaft and that extends at least partially through the densification area;
a second set of blade wheels, each blade wheel of the second set having a peripheral surface with two or more blades extending therefrom and a central aperture for mounting each blade wheel of the second set to the second shaft, the second set of blade wheels mountable to the second shaft to form a second reconfigurable rotatable shredding assembly, the first and second rotatable shredding assemblies positioned to form a mesh between the first and second sets of blade wheels; and
wherein each of the first and second sets of blade wheels are configured to be mounted to the first and second shafts in at least a first mesh configuration and a second mesh configuration.

16. The recyclable material densification device of claim 15, wherein the first mesh configuration comprises blade wheels of the first and second sets of blade wheels arranged such that adjacent blade wheels of the first shredding assembly are separated by a blade wheel of the second shredding assembly.

17. The recyclable material densification device of claim 15, wherein the first mesh configuration has lateral spaces of about 0.7 inches and overlapped spaces of about 1.4 inches.

18. The recyclable material densification device of claim 16, wherein the second mesh configuration comprises blade wheels of the first and second sets arranged in pairs such that adjacent pairs of the first shredding assembly are each separated by a pair of blade wheels of the second shredding assembly.

19. The recyclable material densification device of claim 18, wherein the first and second shredding assemblies are configured such that the mesh has lateral spaces of about 1.4 inches and overlapped spaces of about 1.4 inches.

20. The recyclable material densification device of claim 19, wherein the blades are full width blades.

21. The recyclable material densification device of claim 15, wherein a front face of the housing is removable to provide access to the shredding assemblies for reconfiguration between the first and second mesh configurations.

22. A system for densifying recyclable materials, the system comprising:
a housing defining a densification area, the housing having an opening at an upper surface to receive recyclable materials for densification;
a mechanism positioned interior to the housing, the mechanism configured to densify recyclable materials received in the densification area;
a gate incorporated into a conveyor path that, when opened, allows materials to fall toward the densification area; and
a chute that defines a pathway between the gate and the densification device along which materials travel without incurring substantial contact with the chute or obstacles.

23. The system of claim 22, wherein the housing defines a cross-sectional area of about three square feet.

24. The system of claim 23, wherein the pathway spans about three feet in a vertical direction.

25. The system of claim 22, wherein the chute includes substantially vertical opposed walls that extend between the gate and the housing.

25. The system of claim 22, wherein the mechanism includes opposed shredding assemblies that define a mesh where recyclable materials are densified.

26. A method of manufacturing a system for densifying recyclable materials, the method comprising:
providing a front end module and a back end module;
selecting one or more densification modules from a group consisting of: a first densification module having a plurality of densification devices of a first type, a second densification module having a plurality of densification devices of a second type different from the first type, and a third densification device having one or more each of the first type of densification device and the second type of densification device; wherein the first densification module, the second densification module, and the third densification module each have a commonly designed input face configured to mate with a commonly designed output face of another densification module;
mating an input face of each densification module selected from the group to an output face of another densification module selected from the group or the front end module; and
mating an input face of the back end module to an output face of a densification module selected from the group.

27. The method of claim 26, wherein the first type of densification device comprises a pair of opposed shredding assemblies that define a mesh for densifying recyclable material.

28. The method of claim 26, wherein the second type of densification device comprises a rotating member configured for smashing glass bottles.

29. The method of claim 26, wherein each of the first densification modules, the second densification modules, and the third densification modules includes a platform for holding a bin beneath a densification device to receive densified, recyclable material.

30. The method of claim 26, wherein the front end module includes a scanning device that scans a material to be recycled to identify which densification device is to receive and densify the material.
